(19) United States
(12) Patent Application Publication
(10) Pub. No.: US 2025/0317879 A1
(43) Pub. Date: Oct. 9, 2025

(54) IMPLICIT TIMING ADVANCE UPDATE FOR DEACTIVATED CELL OR TIMING ADVANCE GROUP

(71) Applicant: QUALCOMM Incorporated, San Diego, CA (US)

(72) Inventors: Yan ZHOU, San Diego, CA (US); Fang YUAN, Beijing (CN); Tao LUO, San Diego, CA (US); Peter GAAL, San Diego, CA (US); Mostafa KHOSHNEVISAN, San Diego, CA (US); Jing SUN, San Diego, CA (US)

(21) Appl. No.: 18/865,008

(22) PCT Filed: Jul. 15, 2022
(86) PCT No.: PCT/CN2022/105901

§ 371 Date: Nov. 12, 2024

(51) Int. Cl. H04W 56/00; H04L 5/00; H04W 72/0457

(52) U.S. Cl. CPC H04W 56/0045; H04L 5/0051; H04W 56/0015; H04W 72/0457

(57) ABSTRACT

Various aspects of the present disclosure generally relate to wireless communication. In some aspects, a user equipment (UE) may measure a downlink reception timing difference between a reference active cell in a first timing advance group (TAG) and a reference deactivated cell in a second TAG, wherein the second TAG is a deactivated TAG. The UE may derive a timing advance for the second TAG based at least in part on a timing advance for the first TAG and the downlink reception timing difference between the reference active cell and the reference deactivated cell. The UE may transmit, on one or more cells in the second TAG, one or more uplink communications using the timing advance for the second TAG, in connection with activation of the one or more cells in the second TAG. Numerous other aspects are described.

### FIELD OF THE DISCLOSURE

Aspects of the present disclosure generally relate to wireless communication and to techniques and apparatuses for implicit timing advance updates for a deactivated cell or timing advance group.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some examples, when a new primary cell (PCell) is activated for a user equipment (UE) in cases of layer 1 (L1) and/or layer 2 (L2) mobility (L1/L2 mobility), the UE may receive a timing advance command that indicates a timing advance for the new PCell. However, such explicit signaling of the updated timing advance for the new PCell may increase PCell activation latency for the UE. In some aspects, to decrease PCell activation latency, it may be beneficial for the UE to maintain the TA for a deactivated candidate PCell, such that no TA update is needed after the deactivated candidate PCell is selected as the new PCell for the UE.

Some techniques and apparatuses described herein enable a UE to perform an implicit update for a deactivated cell or deactivated timing advance group (TAG). In some aspects, the UE may measure a downlink reception timing difference between a reference active cell in a first TAG and a reference deactivated cell in a second TAG (e.g., a deactivated TAG). The UE may derive a timing advance for the second TAG based at least in part on a timing advance for the first TAG and the downlink reception timing difference between the reference active cell and the reference deactivated cell. The UE may transmit, on one or more cells in the second TAG, one or more uplink communications using the timing advance for the second TAG, in connection with activation of the one or more cells in the second TAG. As a result, PCell activation latency may be reduced for the UE in cases of L1/L2 mobility.

Some aspects described herein relate to a UE for wireless communication. The UE may include a memory and one or more processors coupled to the memory. The one or more processors may be configured to measure a downlink reception timing difference between a reference active cell in a first TAG and a reference deactivated cell in a second TAG, wherein the second TAG is a deactivated TAG. The one or more processors may be configured to derive a timing advance for the second TAG based at least in part on a timing advance for the first TAG and the downlink reception timing difference between the reference active cell and the reference deactivated cell. The one or more processors may be configured to transmit, on one or more cells in the second TAG, one or more uplink communications using the timing advance for the second TAG, in connection with activation of the one or more cells in the second TAG.

Some aspects described herein relate to a method of wireless communication performed by a UE. The method may include measuring a downlink reception timing difference between a reference active cell in a first TAG and a reference deactivated cell in a second TAG, wherein the second TAG is a deactivated TAG. The method may include deriving a timing advance for the second TAG based at least in part on a timing advance for the first TAG and the downlink reception timing difference between the reference active cell and the reference deactivated cell. The method may include transmitting, on one or more cells in the second TAG, one or more uplink communications using the timing advance for the second TAG, in connection with activation of the one or more cells in the second TAG.

Some aspects described herein relate to a non-transitory computer-readable medium that stores a set of instructions for wireless communication by a UE. The set of instructions, when executed by one or more processors of the UE, may cause the UE to measure a downlink reception timing difference between a reference active cell in a first TAG and a reference deactivated cell in a second TAG, wherein the second TAG is a deactivated TAG. The set of instructions, when executed by one or more processors of the UE, may cause the UE to derive a timing advance for the second TAG based at least in part on a timing advance for the first TAG and the downlink reception timing difference between the reference active cell and the reference deactivated cell. The set of instructions, when executed by one or more processors of the UE, may cause the UE to transmit, on one or more cells in the second TAG, one or more uplink communications using the timing advance for the second TAG, in connection with activation of the one or more cells in the second TAG.

Some aspects described herein relate to an apparatus for wireless communication. The apparatus may include means for measuring a downlink reception timing difference between a reference active cell in a first TAG and a reference deactivated cell in a second TAG, wherein the second TAG is a deactivated TAG. The apparatus may include means for deriving a timing advance for the second TAG based at least in part on a timing advance for the first TAG and the downlink reception timing difference between the reference active cell and the reference deactivated cell. The apparatus may include means for transmitting, on one or more cells in the second TAG, one or more uplink communications using the timing advance for the second TAG, in connection with activation of the one or more cells in the second TAG.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of downlink and uplink transmissions between a network node and a UE in a wireless network, in accordance with the present disclosure.

FIG. 5 is a diagram illustrating an example of primary cell (PCell) reselection in connection with UE mobility, in accordance with the present disclosure.

FIGS. 6-13C are diagrams illustrating examples associated with implicit timing advance (TA) updates for a deactivated cell or timing advance group (TAG), in accordance with the present disclosure.

FIG. 14 is a diagram illustrating an example process performed, for example, by a UE, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

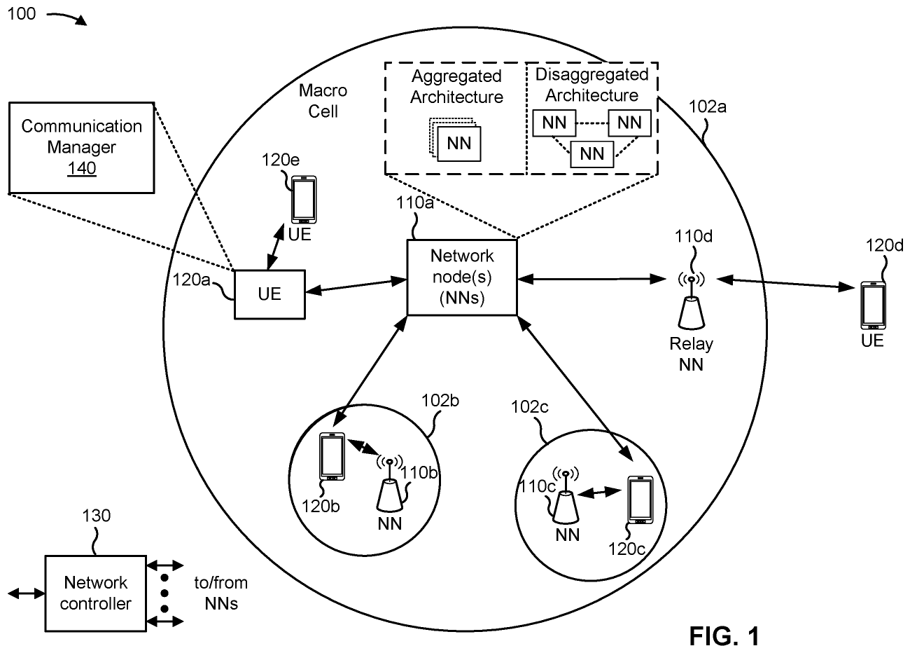

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may measure a downlink reception timing difference between a reference active cell in a first timing advance group (TAG) and a reference deactivated cell in a second TAG, wherein the second TAG is a deactivated TAG; derive a timing advance (TA) for the second TAG based at least in part on a TA for the first TAG and the downlink reception timing difference between the reference active cell and the reference deactivated cell; and transmit, on one or more cells in the second TAG, one or more uplink communications using the TA for the second TAG, in connection with activation of the one or more cells in the second TAG. Additionally, or alternatively, the communication manager 140 may perform one or more other operations described herein.

As indicated above, FIG. 1 is provided as an example. Other examples may differ from what is described with regard to FIG. 1.

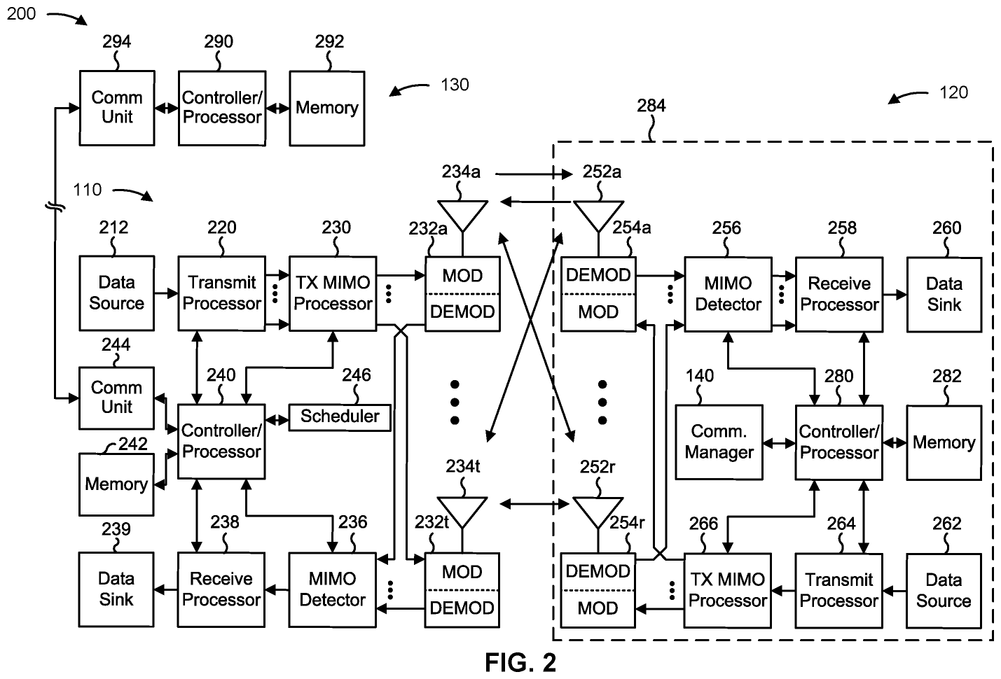

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

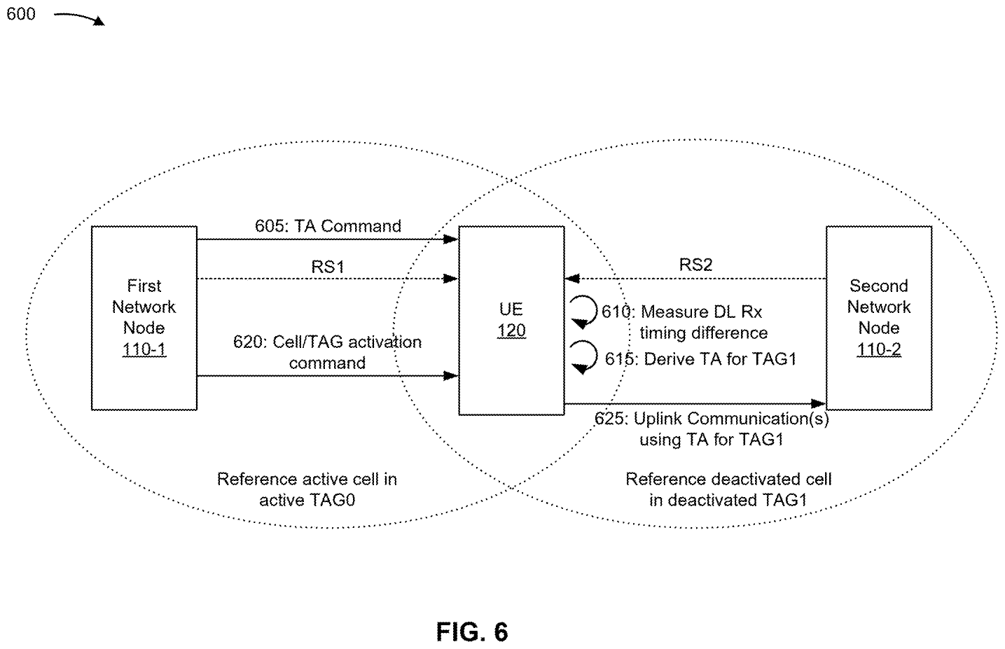

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-15).

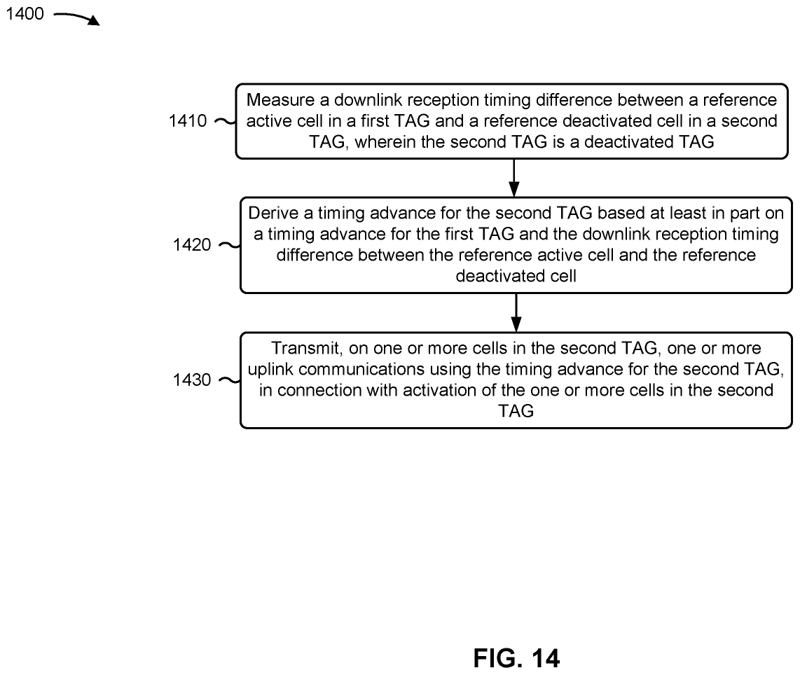

The controller/processor 240 of the network node 110, the controller/processor 280 of the UE 120, and/or any other component(s) of FIG. 2 may perform one or more techniques associated with implicit TA updates for deactivated cell or TAG, as described in more detail elsewhere herein. For example, the controller/processor 240 of the network node 110, the controller/processor 280 of the UE 120, and/or any other component(s) of FIG. 2 may perform or direct operations of, for example, process 1400 of FIG. 14, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1400 of FIG. 14, and/or other processes as described herein. In some examples, executing instructions may include running the instructions, converting the instructions, compiling the instructions, and/or interpreting the instructions, among other examples.

In some aspects, a UE (e.g., the UE 120) includes means for measuring a downlink reception timing difference between a reference active cell in a first TAG and a reference deactivated cell in a second TAG, wherein the second TAG is a deactivated TAG; means for deriving a TA for the second TAG based at least in part on a TA for the first TAG and the downlink reception timing difference between the reference active cell and the reference deactivated cell; and/or means for transmitting, on one or more cells in the second TAG, one or more uplink communications using the TA for the second TAG, in connection with activation of the one or more cells in the second TAG. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

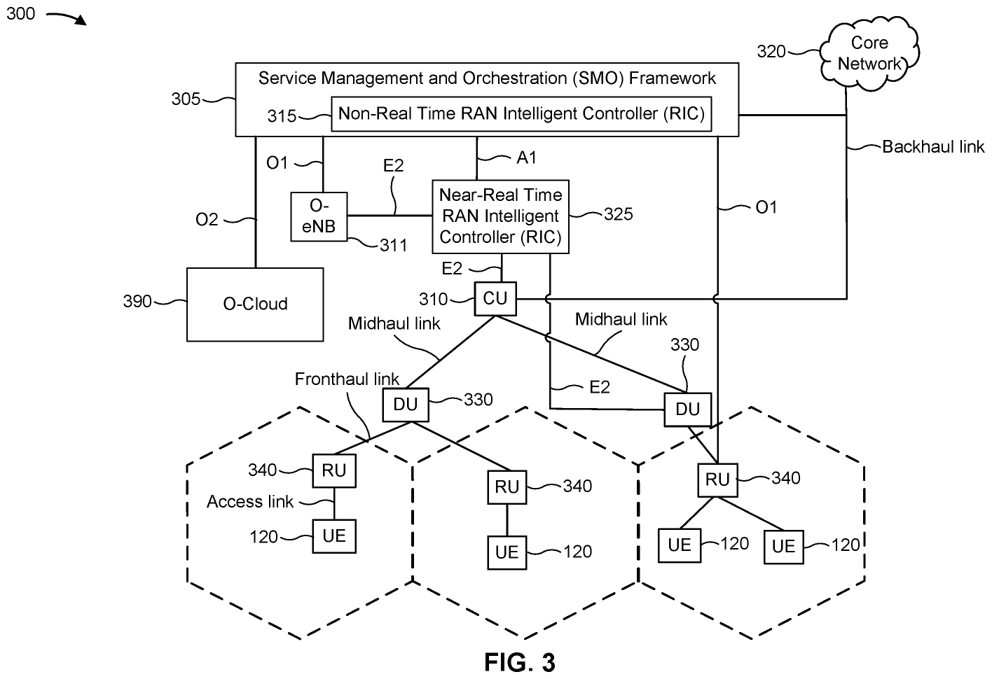

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

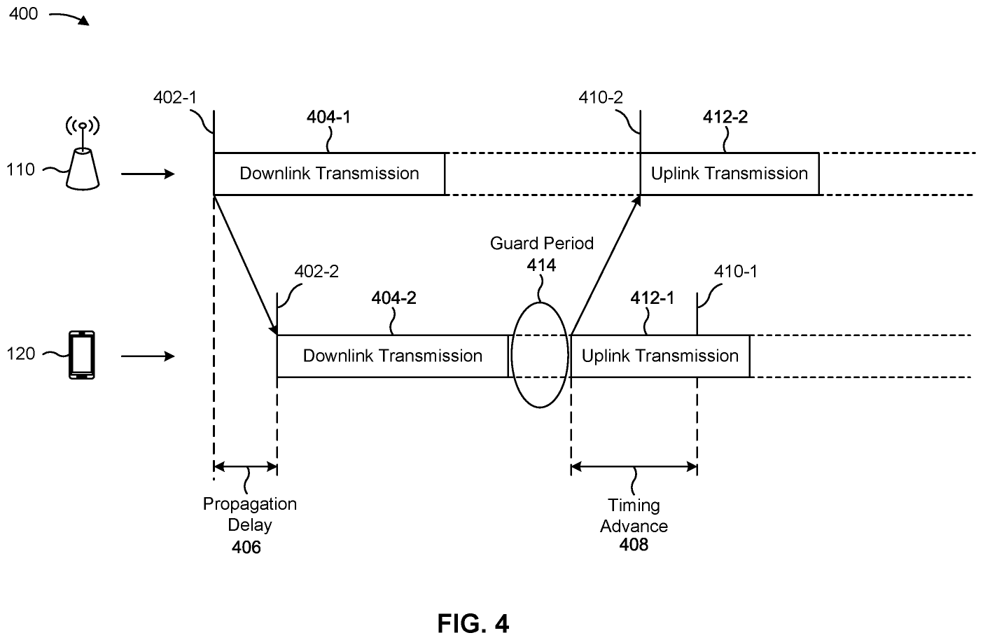

FIG. 4 is a diagram illustrating an example 400 of downlink and uplink transmissions between a network node 110 and a UE 120 in a wireless network 100, in accordance with the present disclosure. In some examples, the downlink and/or uplink transmissions are based at least in part on a TA and/or a guard period between communications. As one example, a network node 110 may configure a downlink transmission to end before the start of a guard period. As another example, the UE 120 may advance a start time for an uplink transmission based at least in part on a TA.

As shown by reference number 402-1, a network node 110 may begin a downlink transmission 404-1 to a UE 120 at a first point in time. In some examples, the first point in time may be based at least in part on a timing scheme defined by a telecommunication system and/or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots and/or each slot may include a set of L symbol periods (e.g., fourteen symbol periods, seven symbol periods, or another number of symbol periods). Thus, the first point in time as shown by the reference number 402-1 may be based at least in part on a time partition as defined by a telecommunication system (e.g., a frame, a subframe, a slot, a mini-slot, and/or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 402-1, the network node 110 may begin the downlink transmission 404-1 at a particular point in time that may be associated with a defined time partition based at least in part on a time perspective of the network node 110. For example, the network node 110 may associate the particular point in time with a defined time partition, such as a beginning of a symbol, a beginning of a slot, a beginning of a subframe, and/or a beginning of a frame. However, the downlink transmission may incur a propagation delay 406 in time, such as a time delay based at least in part on the downlink transmission traveling between a network node 110 (e.g., an RU) and the UE 120. As shown by reference number 402-2, the UE 120 may receive downlink transmission 404-2 (corresponding to downlink transmission 404-1 transmitted by the network node 110) at a second point in time that is later in time relative to the first point in time. From a time perspective of the UE 120, however, the UE 120 may associate the second point in physical time shown by the reference number 402-2 with the same particular point in time of the defined time partition as the network node 110 (e.g., a beginning of the same symbol, a beginning of the same mini-slot, a beginning of the same slot, a beginning of the same subframe, and/or a beginning of the same frame). Thus, as shown by the example 400, the time perspective of the UE 120 may be delayed in time from the time perspective of the network node 110.

In wireless communication technologies like 4G/LTE and 5G/NR, a TA value is used to control a timing of uplink transmissions by a UE (e.g., the UE 120) such that the uplink transmissions are received by a network node 110 (e.g., an RU) at a time that aligns with an internal timing of the network node 110. A network node 110 may determine the TA value to a UE (e.g., directly or via one or more network nodes) by measuring a time difference between reception of uplink transmissions from the UE and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. The TA command is used to offset timing differences between the UE and the network node 110 due to different propagation delays that occur when the UE is different distances from the network node 110. If TA commands were not used, then uplink transmissions from different UEs (e.g., located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 410-1, a start of the scheduled point in time may occur at a third physical point in time based at least in part on the timing perspective of the UE 120. However, and as shown by reference number 410-2, the scheduled point in time with reference to the timing perspective of the network node 110 (e.g., an RU) may occur at a fourth point in physical time that occurs before the third point in physical time as shown by the reference number 410-1. Accordingly, the network node 110 may instruct the UE 120 (e.g., directly or via one or more network nodes) to apply a timing advance 408 to an uplink transmission to better align reception of the uplink transmission with the timing perspective of the network node 110. However, in some examples, the fourth point in time shown by the reference number 410-2 may occur at or near a same physical point in time as the third point in time shown by the reference number 410-1 such that uplink transmissions from the UE 120 to the network node 110 incur the propagation delay 406. In such a scenario, the network node 110 may instruct the UE 120 to apply a timing advance with a time duration corresponding to the propagation delay 406.

As shown by the example 400, the UE 120 may adjust a start time of an uplink transmission 412-1 based at least in part on the timing advance 408 and the start of the scheduled point in time (e.g., at the third physical point in time shown by the reference number 410-1). Based at least in part on propagation delay, the network node 110 may receive an uplink transmission 412-2 (corresponding to the uplink transmission 412-1 transmitted by the UE 120) at the fourth point in physical time shown by the reference number 410-2.

In some examples, a timing advance value may be based at least in part on twice an estimated propagation delay (e.g., the propagation delay 406) and/or may be based at least in part on a round trip time (RTT). A network node 110 (e.g., a DU or a CU) may estimate the propagation delay and/or select a timing advance value based at least in part on communications with the UE 120. As one example, the network node 110 may estimate the propagation delay based at least in part on a network access request message from the UE 120. Additionally, or alternatively, the network node 110 may estimate and/or select the timing advance value from a set of fixed timing advance values.

In some examples, a telecommunication system and/or telecommunication standards may define a guard period 414 (e.g., a time duration) between transmissions to provide a device with sufficient time for switching between different transmission and/or reception modes, for transient settling, to provide a margin for timing misalignment between devices, and/or for propagation delays. In some examples, a guard period is a period during which no transmissions or receptions are scheduled and/or allowed to occur. A guard period may provide a device with sufficient time to reconfigure hardware and/or allow the hardware to settle within a threshold value to enable a subsequent transmission. The guard period 414 may sometimes be referred to as a gap, a switching guard period, or a guard interval.

In some examples, a network node 110 (e.g., a DU or a CU) may select a starting transmission time and/or a transmission time duration based at least in part on a receiving device and/or the guard period. For example, the network node 110 may select an amount of content (e.g., data and/or control information) to transmit in the downlink transmission 404-1 based at least in part on beginning the transmission at the first point in time shown by the reference number 402-1 and/or the UE 120 completing reception of the downlink transmission 404-2 prior to a starting point of the guard period 414. Alternatively, or additionally, the UE 120 may select an amount of content (e.g., data and/or control information) to transmit in the uplink transmission 412-1 based at least in part on the timing advance 408, the third point in time shown by the reference number 410-1, and/or refraining from beginning the uplink transmission 412-1 until the guard period 414 has ended.

As indicated above, FIG. 4 is provided as an example. Other examples may differ from what is described with regard to FIG. 4.

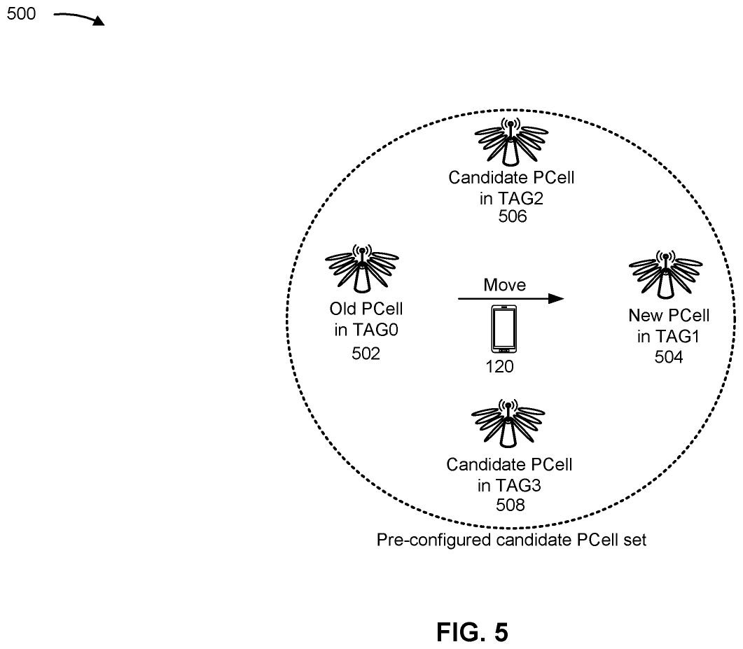

FIG. 5 is a diagram illustrating an example 500 of primary cell (PCell) reselection in connection with UE mobility, in accordance with the present disclosure.

In some examples (e.g., in cases of carrier aggregation), a UE (e.g., UE 120) may be configured with multiple serving cells, including a PCell and one or more secondary cells (SCells). The PCell may also be referred to a primary carrier or primary component carrier (CC), and the SCells may also be referred to as secondary carriers or secondary CCs. In some examples (e.g., in cases of multiple connectivity), a UE may communicate with multiple cell groups, including a master cell group (MCG) and one or more secondary cell groups (SCGs). For example, different cell groups may be associated with different network nodes located at different physical cell sites. Each cell group (e.g., the MCG and the SCG(s)) may include a PCell and one or more SCells. The PCell of an SCG may be referred to as a primary secondary cell (PSCell).

As shown in FIG. 5, in layer 1 (L1) and/or layer 2 (L2) mobility (L1/L2 mobility), as a UE 120 moves, the PCell may be reselected or updated from an old PCell 502 to a new PCell 504. In this case, the PCell may be reselected or updated to a new PCell (e.g., PCell 504) among a set of pre-configured candidate PCells based at least in part on L1 measurements for the candidate PCells performed by the UE 120. For example, as shown in FIG. 5, the set of candidate PCells may include the network entity PCell 504 and candidate PCells 506 and 508. In some cases, one or more of the candidate PCells may not be activated for the UE 120 prior to one of the candidate PCells being selected as the new PCell. For example, the new PCell 504 may be deactivated prior to being selected as the new PCell for the UE 120.

In some examples, the PCells may be assigned to TAGs. A TAG is group of one or more serving cells with the same uplink TA. For example, the old PCell 502 may be in a first TAG (TAG0), the new PCell 504 may be in a second TAG (TAG1), the candidate PCell 506 may be in a third TAG (TAG2), and the candidate PCell 508 may be in a fourth TAG (TAG3). In some examples, multiple TAGs may be configured for a UE 120 (e.g., via RRC signaling). Each TAG may include at least one serving cell with configured uplink. A TAG that includes a PCell may be referred to a primary TAG (pTAG), and a TAG that includes only one or more SCells, and no PCell, may be referred to a secondary TAG (sTAG).

In a case in which a TAG is assigned to a deactivated candidate PCell, there may be other cells that share the same TAG with the candidate PCell. For example, the TAG may include the candidate PCell and one or more SCells in a candidate cell group associated with a physical cell site. In some examples, all candidate cells in the same TAG may be deactivated prior to selection of the new PCell. For example, all candidate cells included in the same TAG (TAG1) as the new PCell 504 may be deactivated prior to the new PCell 504 being selected for the UE 120. As used herein, “deactivated TAG” refers to a TAG including only deactivated cells, and “active TAG” refers to a TAG including at least one active cell.

In some examples, when the new PCell 504 is activated for the UE 120, the UE 120 may receive a TA command that indicates the TA for the new PCell 504 (e.g., the TA for the TAG1). However, such explicit signaling of the updated TA for the new PCell 504 increases PCell activation latency for the UE 120. In some aspects, to decrease PCell activation latency, it may be beneficial for the UE 120 to maintain the TA for a deactivated candidate PCell, such that no TA update is needed after the candidate PCell is selected as the new PCell for the UE 120. However, it may be difficult to maintain the TA for a deactivated cell or a deactivated TAG (which includes only deactivated cells) while complying with provisions in a current wireless communication standard (e.g., a current 3GPP standard) regarding a deactivated cell. For example, in the current 3GPP standard, a UE may not transmit a PRACH, sounding reference signal (SRS), or physical uplink control channel (PUCCH) on the deactivated PCell/SCell, the UE may not receive a physical downlink control channel (PDCCH) on or for the deactivated PCell/SCell, and the UE may not report channel state information (CSI) for the deactivated PCell/SCell. In this case, a network node may not be able to determine the TA for the deactivated cell or deactivated TAG for the UE.

Some techniques and apparatuses described herein enable a UE to perform an implicit update for a deactivated cell or deactivated TAG. In some aspects, the UE may measure a downlink reception timing difference between a reference active cell in a first TAG and a reference deactivated cell in a second TAG (e.g., a deactivated TAG). The UE may derive a TA for the second TAG based at least in part on a TA for the first TAG and the downlink reception timing difference between the reference active cell and the reference deactivated cell. The UE may transmit, on one or more cells in the second TAG, one or more uplink communications using the TA for the second TAG, in connection with activation of the one or more cells in the second TAG. As a result, PCell activation latency may be reduced in cases of L1/L2 mobility. Furthermore, the UE may maintain the TA for a deactivated cell or deactivated TAG, and thus reduce the PCell activation latency, while complying with provisions regarding a deactivated cell in a wireless communication standard (e.g., a current 3GPP standard).

As indicated above, FIG. 5 is provided as an example. Other examples may differ from what is described with respect to FIG. 5.

FIG. 6 is a diagram illustrating an example 600 associated with implicit TA updates for a deactivated cell or TAG, in accordance with the present disclosure. As shown in FIG. 6, example 600 includes communication between a UE 120, a first network node 110-1, and a second network node 110-2. In some aspects, the first network node 110-1, the second network node 110-2, and the UE 120 may be included in a wireless network, such as wireless network 100. The UE 120 may communicate with the first network node 110-1 and the second network node 110 via wireless access links, which may include uplinks and downlinks.

In some aspects, the first network node 110-1 may be associated with one or more cells (e.g., a cell group) that are included in a first TAG (TAG0). TAG0 may be an active TAG, that includes one or more active cells. In some aspects, the second network node 110-2 may be associated with one or more cells (e.g., a cell group) that are included in a second TAG (TAG1). TAG1 may be a deactivated TAG. In this case, all of the cells included in TAG1 may be deactivated for the UE 120.

As shown in FIG. 6, and by reference number 605, the first network node 110-1 may transmit, to the UE 120, a TA command that includes an indication of the TA for TAG0 (e.g., the active TAG). The UE 120 may receive, from the first network node 110-1, the TA command that includes the indication of the TA for TAG0. For example, the first UE 120-1 may receive the TA command on a cell (e.g., a PCell) included in TAG0. The UE 120 may apply the TA value, indicated by the TA command, for uplink communications (e.g., to the first network node 110-1) on all cells included in TAG0.

As further shown in FIG. 6, and by reference number 610, the UE 120 may measure a downlink reception (Rx) timing difference between a reference active cell in TAG0 (e.g., the active TAG) and a reference deactivated cell in TAG1 (e.g., the deactivated TAG).

In some aspects, to measure the downlink Rx timing difference, the UE 120 may determine or identify the active TAG and the deactivated TAG for which the downlink Rx timing difference is to be calculated. In some aspects, the UE 120 may determine the active TAG based at least in part on a rule. For example, in some aspects, the UE 120 may use a pTAG (e.g., the active pTAG) as the active TAG. In some aspects, the UE 120 may use an sTAG, of one or more active sTAGs, as the active TAG. In this case, the UE 120 may select an active sTAG, from a set of one or more active sTAGs, based at least in part on a TAG identifier (ID). For example, the UE 120 may select the active sTAG with a lowest TAG ID or a highest TAG ID among the set of one or more active sTAGs. In some aspects, an indication of a TAG ID that identifies the active TAG may be explicitly signaled to the UE 120. In this case, a network node (e.g., the first network node 110-1) may transmit, and the UE 120 may receive, the indication of the TAG ID that identifies the active TAG. For example, the indication of the TAG ID that identifies the active TAG may be included in an RRC message, a medium access control (MAC) control element (MAC-CE), or downlink control information (DCI).

In some aspects, an indication of a TAG ID that identifies the deactivated TAG may be explicitly signaled to the UE 120. In this case, a network node (e.g., the first network node 110-1) may transmit, and the UE 120 may receive, the indication of the TAG ID that identifies the deactivated TAG. For example, the indication of the TAG ID that identifies the active TAG may be included in an RRC message, a MAC-CE, or DCI. In some aspects, the UE 120 may determine the deactivated TAG based at least in part on a rule. For example, the deactivated TAG to be used for the downlink Rx timing difference measurement may be any deactivated TAG that includes one or more candidate special cells (SpCells). “SpCell” refers to a primary cell of any cell group. For example, an SpCell may be a PCell or an PSCell. In some aspects, the UE 120 may select the deactivated TAG from one or more deactivated TAGs that include one or more candidate SpCells. As shown in FIG. 6, in example 600, the active TAG may be TAG0 and the deactivated TAG may be TAG1.

In some aspects, the UE 120 may determine the reference active cell and the reference deactivated cell for the downlink Rx timing difference measurement. The reference active cell may be an active cell included in the active TAG (e.g., TAG0) identified by the UE 120, and the reference deactivated cell may be a deactivated cell included in the deactivated TAG (e.g., TAG1) identified by the UE 120. In some aspects, the UE 120 may determine the reference activated cell and/or the reference deactivated cell based at least in part on one or more rules. In some aspects, the reference activated cell may be an SpCell in the active TAG, and the reference deactivated cell may be a candidate SpCell in the deactivated TAG. In this case, if there is only one candidate SpCell in the deactivated TAG, the UE 120 may select the one candidate SpCell in the deactivated TAG as the reference deactivated cell. If there are multiple candidate SpCells in the deactivated TAG, the UE 120 may select any candidate SpCell of the multiple candidate SpCells as the reference deactivated cell, or the UE 120 may apply a rule to select from among the multiple candidate SpCells. For example, the UE 120 may select, from the multiple candidate SpCells in the deactivated TAG, a candidate SpCell having a lowest or highest candidate cell ID, a lowest or highest serving cell ID, or a lowest or highest physical cell ID (PCI).

In some aspects, the reference active cell and/or the reference deactivated cell may be explicitly signaled to the UE 120. For example, a network node (e.g., the first network node 110-1) may transmit, to the UE 120, an indication that identifies the reference active cell and/or the reference deactivated cell. The UE 120 may receive the indication that identifies the reference active cell and/or the reference deactivated cell. In some aspects, the indication may identify the reference active cell and/or the reference deactivated cell using a serving cell ID, a candidate cell ID, or a PCI. In some aspects, the indication that identifies the reference active cell and/or the reference deactivated cell may be included in an RRC message, a MAC-CE, or DCI.

In some aspects, the UE 120 may measure the downlink Rx timing difference between the reference active cell in the active TAG (e.g., TAG0) and the reference deactivated cell in the deactivated TAG (e.g., TAG1) based at least in part on a first reference signal (RS1) in a first bandwidth part (BWP) associated with the reference active cell and a second reference signal (RS2) in a second BWP associated with the reference deactivated cell. In some aspects, to measure the downlink Rx timing difference, the UE 120 may determine or identify the first BWP associated with the reference active cell and the second BWP associated with the reference deactivated cell. In some aspects, the first BWP may be an active downlink BWP associated with the reference active cell. In some aspects, the second BWP may be determined based at least in part on a rule. For example, the second BWP may be an initial downlink BWP or a first active downlink BWP associated with the reference deactivated cell, a downlink BWP with a lowest BWP ID in a set of downlink BWPs associated with the reference deactivated cell, or a downlink BWP with a highest BWP ID in the set of downlink BWPs associated with the reference deactivated cell. In some aspects, an indication of the second BWP may be explicitly signaled to the UE 120. In this case, a network node (e.g., the first network node 110-1) may transmit, and the ULE 120 may receive, an indication of a downlink BWP ID that identifies the second BWP associated with the reference deactivated cell. For example, the indication of the downlink BWP ID that identifies the second BWP may be included in an RRC message, a MAC-CE, or DCI.

In some aspects, to measure the downlink Rx timing difference, the UE 120 may determine or identify the first reference signal (RS1) and the second reference signal (RS2) on which to measure the Rx timing difference. RS1 may be a downlink reference signal (e.g., a synchronization signal block (SSB) or a CSI reference signal (CSI-RS)) transmitted (e.g., by the first network node 110-1) on the reference active cell, and RS2 may be a downlink reference signal (e.g., an SSB or a CSI-RS) transmitted (e.g., by the second network node 110-2) on the reference deactivated cell. In some aspects, RS1 and RS2 may be periodic reference signals. In some aspects, RS1 and RS2 may be reference signals included in periodic reference signal sets. In some aspects, the UE 120 may determine the reference signals to be measured (e.g., RS1 and RS2) based at least in part on a rule. For example, in some aspects, RS1 may be a strongest SSB associated with the reference active cell, and RS2 may be a strongest SSB associated with the reference deactivated cell. In some aspects, RS1 may be a downlink reference signal (e.g., an SSB or CSI-RS) associated with an active or indicated transmission configuration indicator (TCI) state for the reference active cell, and RS2 may be a downlink reference signal (e.g., an SSB or CSI-RS) associated with an indicated TCI state for the reference deactivated cell.

In some aspects, one or both of the reference signals to be measured (e.g., RS1 and RS2) may be explicitly signaled to the UE 120. In this case, a network node (e.g., the first network node 110-1) may transmit, and the UE 120 may receive, an indication of a first reference signal ID that identifies RS1 and/or a second reference signal ID that identifies RS2. For example, the indication of the first reference signal ID and/or the second reference signal ID may be included in an RRC message, a MAC-CE, or DCI. In some aspects, the UE 120 may autonomously select RS1 from a first set of downlink reference signals configured for the reference active cell, and the UE 120 may autonomously select RS2 from a second set of downlink reference signals configured for the reference deactivated cell.

In some aspects, explicit indications and rule-based determinations may be jointly used for the determination of the active and deactivated TAGs, the reference active and deactivated cells, the first and second BWPs, and/or the first and second reference signals. For example, the UE 120 may use rule-based determination in a case in which the UE 120 does not receive an explicit indication of the active TAG, the deactivated TAG, the reference active cell, the reference deactivated cell, the first BWP, the second BWP, RS1, or RS2.

As shown in FIG. 6, the first network node 110-1 may transmit RS1, and the second network node 110-2 may transmit RS2. For example, the first network node 110-1 may transmit RS1 in the first BWP on the reference active cell in TAG0, and the second network node 110-2 may transmit RS2 in the second BWP on the reference deactivated cell in TAG1. The UE 120 may measure the downlink Rx timing difference between the reference active cell and the reference deactivated cell based at least in part on RS1 and RS2. For example, the UE 120 may measure the downlink Rx timing difference based at least in part on a time at which RS1 is received on the reference active cell and a time at which RS2 is received on the reference deactivated cell. In some aspects, the UE 120 may measure the downlink Rx timing difference as a time difference between first detected paths (in time) of corresponding downlink frames from the reference active cell and the reference deactivated cell. In some aspects, the UE 120 may measure the downlink Rx timing difference as a time difference between strongest detected paths (in time) of the corresponding downlink frames from the reference active cell and the reference deactivated cell.

In a case in which the reference active cell and the reference deactivated cell are in widely separated frequencies/bands, the downlink Rx timing difference may be large, and the measurement of the downlink Rx timing difference may be subject to error due to different propagation, subcarrier spacing (SCS), and downlink frame transmission timing. For example, a maximum absolute deviation in frame start timing between any pair of cells on the same frequency that have overlapping coverage areas may only be specified for time division duplex (TDD) as 3 micro-seconds (μs), and may be unspecified for a case in which the pair of cells are on different frequencies. In some aspects, to ensure an downlink Rx timing difference with a limited range and high accuracy, the frequencies of reference active and deactivated cells and/or the SCSs of RS1 and RS2 may be required to be within a certain range. In some aspects, the reference signals of the reference active and deactivate cells (e.g., RS1 and RS2) may be required to have a same center frequency and a same SCS. For example, RS1 and RS2 may be SSBs that have the same center frequency and the same SCS. In some aspects, the reference active cell and the reference deactivated cell may be required to be in the same frequency band. In some aspects, the frequencies of the reference active cell and the reference deactivated cell may be required to be within a certain frequency range (e.g., a difference between the frequencies of the reference active cell and the reference deactivated cell may be required to satisfy a threshold).

In some aspects, the UE 120 may determine whether the measured downlink Rx timing difference (and/or the corresponding derived TA for the deactivated TAG) is within a range that satisfies an accuracy requirement. For example, the UE 120 may determine whether an absolute error of the measured Rx timing difference satisfies a threshold. The accuracy requirement (e.g., the threshold value) may be based at least in part on one or more conditions. For example, the accuracy requirement may be conditioned based at least in part on a given SCS and frequency range per reference cell, a determination of whether a reception quality per measured reference signal satisfies a threshold, and/or a determination of whether a downlink transmission (Tx) timing difference and/or the downlink Rx timing difference between the reference cells are within a certain range (e.g., satisfy a threshold). In some aspects, the UE 120 may determine whether to derive the TA for the deactivated TAG (e.g., TAG1) based at least in part on the determination of whether the measured downlink Rx timing difference satisfies the accuracy requirement. For example, the UE 120 may proceed with deriving the TA for the deactivated TAG in connection with a determination that the measured downlink Rx timing difference satisfies the accuracy requirement.

In some aspects, the UE 120 may determine whether a first reception quality measurement (e.g., a first RSRP measurement) associated with RS1 and a second reception quality measurement (e.g., a second RSRP measurement) associated with RS2 satisfy a threshold. In this case, the UE 120 may proceed with deriving the TA for the deactivated TAG (e.g., TAG1) in connection with a determination that the first reception quality measurement associated with the first reference signal and the second reception quality measurement associated with the second reference signal satisfy the threshold. In some aspects, the UE 120 may determine whether a downlink Tx timing difference between the reference active cell and the reference deactivated cell satisfies a threshold (e.g., 3 μs), and/or whether the downlink Rx timing difference between the reference active cell and the reference deactivated cell satisfies a threshold (e.g., 3 μs). In this case, the UE 120 may proceed with deriving the TA for the deactivated TAG (e.g., TAG1) in connection with at least one of a determination that the downlink Tx timing difference between the reference active cell and the reference deactivated cell satisfies the threshold or a determination that the downlink Rx timing difference between the reference active cell and the reference deactivated cell satisfies the threshold.

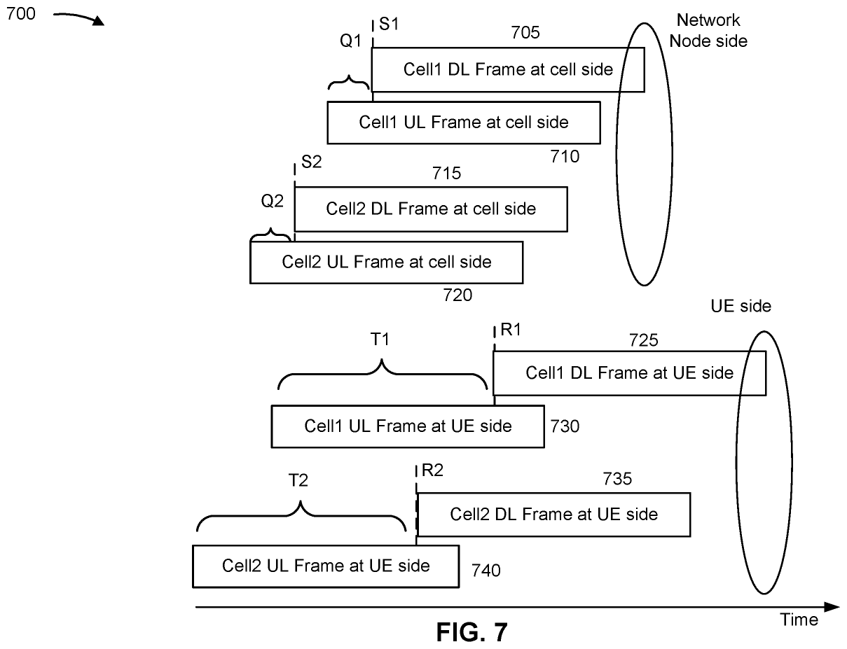

As further shown in FIG. 6, and by reference number 615, the UE 120 may derive a TA for the TAG1 (e.g., the deactivated TAG) based at least in part on the TA for TAG0 (e.g., the active TAG) and the downlink Rx timing difference between the reference active cell and the reference deactivated cell. In some aspects, the UE 120 may determine the TA for the TAG1 based at least in part on the TA for TAG0, the measured downlink Rx timing difference between the reference active cell and the reference deactivated cell, and timing information relating to a downlink Tx timing difference between the reference active cell and the reference deactivated cell and a difference between uplink and downlink timing gaps in the reference active cell and the reference deactivated cell. In some aspects, a network node (e.g., the first network node 110-1) may transmit the timing information to the UE 120 (e.g., via an RRC message, a MAC-CE, or DCI), and the UE 120 may receive the timing information transmitted by the network node (e.g., the first network node 110-1). In some aspects, the UE 120 may derive the TA for TAG1 as: T2=T1−2*[(R1−R2)−(S1−S2)]−(Q1−Q2), where T2 is the TA for TAG1, T1 is the TA for TAG0 (e.g., indicated by the TA command), R1-R2 is the downlink Rx timing difference between the reference active cell and the reference deactivated cell (e.g., measured by the UE 120), S1−S2 is the downlink Tx timing difference between the reference active cell and the reference deactivated cell, and Q1−Q2 is the difference between uplink and downlink timing gaps in the reference active cell and the reference deactivated cell. The derivation of the TA for the deactivated TAG (e.g., TAG1) and the timing information are described in greater detail in connection with FIG. 7.

In some aspects, the measurement of the downlink Rx timing difference and the derivation of the TA for deactivated TAG (e.g., TAG1), performed by the UE 120, may be periodic, semi-persistent, and/or aperiodic, as described in greater detail elsewhere herein.

As further shown in FIG. 6, and by reference number 620, the first network node 110-1 may transmit, to the UE 120, a cell or TAG activation command (cell/TAG activation command) that indicates activation of one or more cells in TAG1. The UE 120 may receive the cell/TAG activation command. For example, the cell or TAG activation command may be included in a MAC-CE or DCI. In some aspects, the first network node 110-1 may transmit the cell or TAG activation command to the UE 120 based at least in part on L1/L2 mobility of the UE 120. In some aspects, the activation command may be a TAG activation command that activates TAG1 (e.g., the previously deactivated TAG). For example, the TAG activation command may activate all cells included in TAG1. In some aspects, the TAG activation command may indicate that the activated TAG is to be used as a new pTAG for the UE 120 (e.g., based at least in part on L1/L2 mobility of the UE 120). In some aspects, the activation command may be a cell activation command that activates one or more of the cells included in TAG1. In some aspects, the cell activation command may indicate that an active cell in the TAG1 is to be used as a network entity SpCell for the UE 120 (e.g., based at least in part on L1/L2 mobility for the UE 120). In some aspects, a TA application time may be associated with the cell or TAG activation command. For example, the TA application may occur at a time offset (e.g., X ms or X symbols) from the cell or TAG activation command. The TA application time may be a time at which the one or more cells in TAG1 are activated for the UE 120, and the UE 120 may begin applying the derived TA (e.g., a latest updated derived TA) for TAG1 at the TA application time.

As further shown in FIG. 6, and by reference number 625, the UE 120 may transmit, on one or more cells in TAG1, one or more uplink communications using the TA for TAG1 (e.g., the TA derived for TAG1 by the UE 120), in connection with the activation of the one or more cells in TAG1. For example, the UE 120 may transmit, to the second network node 110-2, the one or more uplink communications on the one or more cells in TAG1, and the second network node 110-2 may receive the one or more uplink communications. In some aspects, the UE 120 may transmit the one or more uplink communications using the TA derived for TAG1 after the TA application time associated with the cell or TAG activation command. For example, after the TA application time associated with the cell or TAG activation command, the UE 120 may apply the derived TA for TAG1 to an uplink communication on any cell included in TAG1.

In some aspects, when the UE 120 derives the TA for TAG1 (e.g., the deactivated TAG), the UE may store the derived TA, and the UE 120 may apply the stored TA for TAG1 (e.g., the deactivated TAG) once TAG1 is activated. In some aspects, a unit of the derived TA for a deactivated TAG (e.g., TAG1) may be specified when the derived TA is stored at the UE 120. In some aspects, the UE 120 may store a stored value for the derived TA as an absolute time (e.g., in ms). In this case, the UE 120 may convert the signaled TA value for the active TAG (e.g., T1), as well as other inputs (e.g., R1−R2, S1−S2, and/or Q1−Q2) used to derive the TA value (T2) for the deactivated TAG, into absolute time values. In some aspects, the UE 120 may store a stored value for the derived TA as a quantized time based at least in part on a timing unit. For example, the TA value (T2) for the deactivated TAG in absolute time may be further quantized in the timing unit of Tc (e.g., Tc is approximately 0.5 ns as defined in 3GPP specification 38.211), or in an SCS dependent time unit of (16*64/2^{μ})*Tc where the numerology μ corresponds to a particular SCS (e.g., the largest or smallest SCS of all configured uplink BWPs in the deactivated TAG).

In some aspects, the UE 120, when applying the stored TA value for a TAG (e.g., TAG1) to the active cells in the TAG once the TAG is activated, may use an applied value for the TA based at least in part on the stored value for the TA. For example, the UE 120 may round the stored TA value to an applied value in the format T_TA=[X*(16*64/2^{μ})+N_TA,offset]*Tc, where X is a dynamically determined integer, N_TA,offset is a semi-statically determined integer for the TAG, Tc is a timing unit of approximately 0.5 ns, and μ is a numerology factor that corresponds to a particular SCS. In some aspects, N_TA,offset may be configured for the TAG via RRC signaling (e.g., by RRC parameter n-TimingAdvanceOffset), or N_TA,offset may be determined using a default value. In some aspects, the numerology of μ may be determined based at least in part on the SCS of a first uplink transmission after the reception of the cell or TAG activation command. For example, the first uplink transmission may be restricted to be on the SpCell only, or may be on any active cell in the TAG or cell group. In some aspects, the numerology of μ may be determined based at least in part on the SCS of a particular uplink BWP of a CC in the TAG. For example, the numerology of μ may be determined based at least in part on the largest or smallest SCS among all active or configured uplink BWPs of CCs in the TAG, or the numerology of p may be determined based at least in part on the SCS of a reference BWP of a reference CC in the TAG (e.g., an initial uplink BWP of the SpCell).

In some aspects, the UE 120 may report, to a network node (e.g., the first network node 110-1) a UE capability for supporting TA derivation for a deactivated cell or TAG (e.g., a UE capability for supporting implicit TA updates for a deactivated cell or TAG). In this case, the UE 120 may transmit, to a network node (e.g., the first network node 110-1), a UE capability report indicating a UE capability for TA derivation. In some aspects, the UE capability report may indicate a maximum quantity of deactivated cells or TAGs for which TA derivation is supported by the UE 120. In some aspects, the indication of the maximum quantity of deactivated cells or TAGs for which TA derivation is supported may be combined with a maximum quantity of active TAGs for which TA maintenance is supported, for example, as a single indication of a maximum quantity of TAGs for TA maintenance. In some aspects, the UE capability report may indicate one or more time-domain types supported for downlink Rx timing difference measurement and TA derivation. In this case, one or more time-domain types may include one or more of periodic, semi-persistent, and/or aperiodic time-domain types. For example, the UE capability report may indicate whether the UE 120 supports periodic, semi-persistent, and/or aperiodic downlink Rx timing difference measurements, and TA updates based on periodic, semi-persistent, and/or aperiodic reference signals from both cells (e.g., the reference active cell and the reference deactivated cell). In some aspects, the UE capability report may indicate a quantity of time-domain types (e.g., periodic, semi-persistent, and/or aperiodic) supported simultaneously for a deactivated TAG. For example, the UE capability report may indicate, for a given deactivated TAG, whether the UE 120 supports only a single time-domain type (e.g., periodic, semi-persistent, or aperiodic) at a time or multiple time-domain types (e.g., periodic and aperiodic) simultaneously.

As indicated above, FIG. 6 is provided as an example. Other examples may differ from what is described with respect to FIG. 6.

FIG. 7 is a diagram illustrating an example 700 associated with implicit TA updates for a deactivated cell or TAG, in accordance with the present disclosure. As shown in FIG. 7, example 700 shows a downlink frame 705 for a first cell (Cell1) at a network node side (e.g., a cell side), an uplink frame 710 for Cell1 at the network node side (e.g., the cell side), a downlink frame 715 for a second cell (Cell2) at the network node side (e.g., the cell side), an uplink frame 720 for Cell2 at the network node side (e.g., the cell side), a downlink frame 725 for Cell1 at a UE side, an uplink frame 730 for Cell1 at the UE side, a downlink frame 735 for Cell2 at the UE side, and an uplink frame 740 for Cell2 at the UE side. In some aspects, Cell1 may be a reference active cell in an active TAG, and Cell2 may be a reference deactivated cell in a deactivated TAG.

As shown in FIG. 7, T1 is the TA for Cell1, and T2 is the TA for Cell2. R1 is the downlink Rx timing for Cell1 (e.g., a time at which the downlink frame 725 for Cell1 is received by a UE), and R2 is the downlink Rx timing for Cell2 (e.g., a time at which the downlink frame 735 for Cell2 is received by the UE). S1 is the downlink Tx timing for Cell1 (e.g., a time at which the downlink frame 705 for Cell1 is transmitted by a network node), and S2 is the downlink Tx timing for Cell2 (e.g., a time at which the downlink frame 715 for Cell2 is transmitted by a network node). Q1 is an uplink and downlink timing gap for Cell1 (e.g., a difference between the uplink and downlink timing in Cell1), and Q2 is an uplink and downlink timing gap for Cell2 (e.g., a difference between the uplink and downlink timing in Cell2). In some aspects, in a case in which Cell1 is a reference active cell and Cell2 is a reference deactivated cell, the UE (e.g., UE 120) may derive T2 as: T2=T1−2*[(R1-R2)−(S1−S2)]− (Q1−Q2). In this case, the UE may receive an indication of T1 via a TA command on Cell1. The UE may measure the downlink Rx timing difference (R1−R2) between Cell1 and Cell2. In some aspects, a network node may transmit, and the UE may receive, timing information relating to a downlink TX timing difference (S1−S2) between Cell1 and Cell2 and a difference between the uplink and downlink timing gaps (Q1−Q2) in the Cell1 and Cell2. For example, the timing information may be included in an RRC message, a MAC-CE, or DCI.

In some aspects, the timing information, transmitted to the UE from the network node, may include information relating to the downlink and uplink frame timings for the cells (e.g., Cell1 and Cell2) whose downlink Rx timing difference is measured by the UE. In some aspects, the timing information may include a timing offset value that captures the relation of cell-side downlink and uplink frame timings, per cell, as well as across Cell1 and Cell2. In this case, the timing offset value may be based at least in part on the downlink TX timing difference (S1−S2) between Cell1 and Cell2 and the difference between the uplink and downlink timing gaps (Q1−Q2) in the Cell1 and Cell2. For example, the timing offset value, included in the timing information transmitted to the UE, may be equal to 2*[(S1−S2)−(Q1−Q2)].

In some aspects, the timing information, transmitted to the UE from the network node, may include an indication of the downlink Tx timing difference (S1−S2) between Cell1 and Cell2 and/or an indication of an uplink frame timing difference between Cell1 and Cell2. For example, the indication of the uplink frame timing difference, included in the timing information, may be an indication of [(S1−Q1)−(S2−Q2)] or an indication of (Q1−Q2).

In some aspects, the timing information, transmitted to the UE from the network node, may include information relating to the DL frame timing per cell and/or information relating to the uplink frame timing per cell. For example, the timing information may include an indication of the downlink frame timing S1 for Cell1 and an indication of the downlink frame timing S2 for Cell2. Additionally, or alternatively, the timing information may include respective indications of uplink frame timings for the Cell1 and Cell2. For example, the respective indications of the uplink frame timings for Cell1 and Cell2 may include indications of (S1−Q1) and (S2−Q2) or indications of Q1 and Q2. The downlink and/or uplink frame timing per cell may be expressed in absolute time values, or in values relative to a common timing reference (e.g., an earliest or latest downlink or uplink frame timing among all configured candidate cells for L1/L2 Mobility).

In some aspects, the timing information may include frame timing difference information for one of downlink or uplink frames, and the timing information may include individual frame timing information, per cell, for the other one of downlink or uplink frames. For example, the timing information may include the downlink frame timing difference (S1−S2) between Cell1 and Cell2, as well as indications related to individual uplink frame timing, per cell (e.g., indications of Q1 and Q2). In some aspects, Q1 and/or Q2 may be indicated by a network node in n-TimingAdvanceOffset, or by a default value in a wireless communication standard (e.g., a 3GPP standard) if not indicated by the network node.

As indicated above, FIG. 7 is provided as an example. Other examples may differ from what is described with respect to FIG. 7.

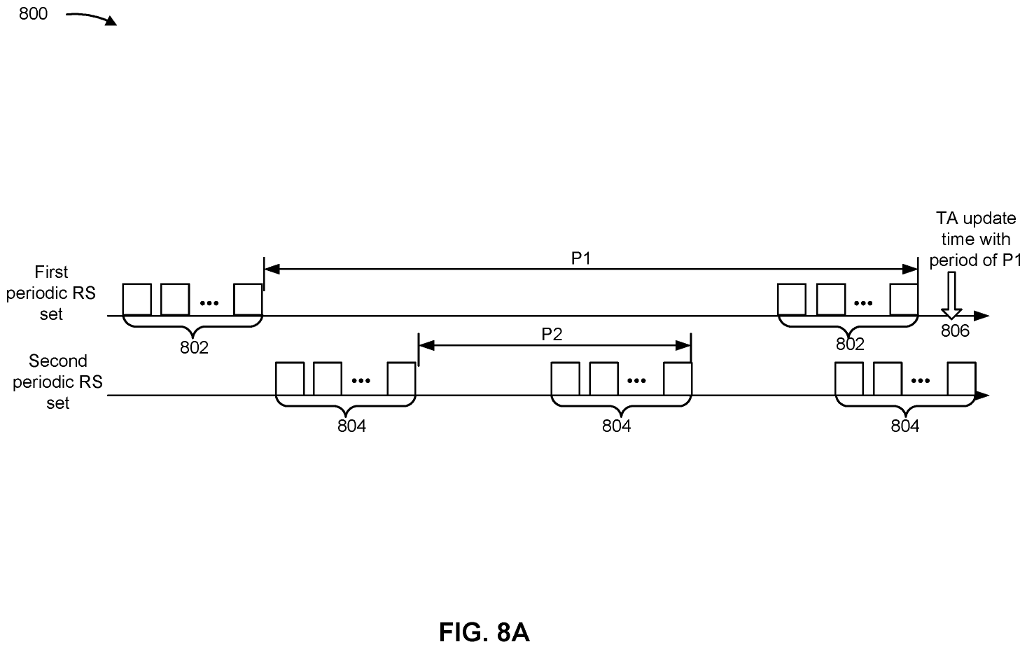

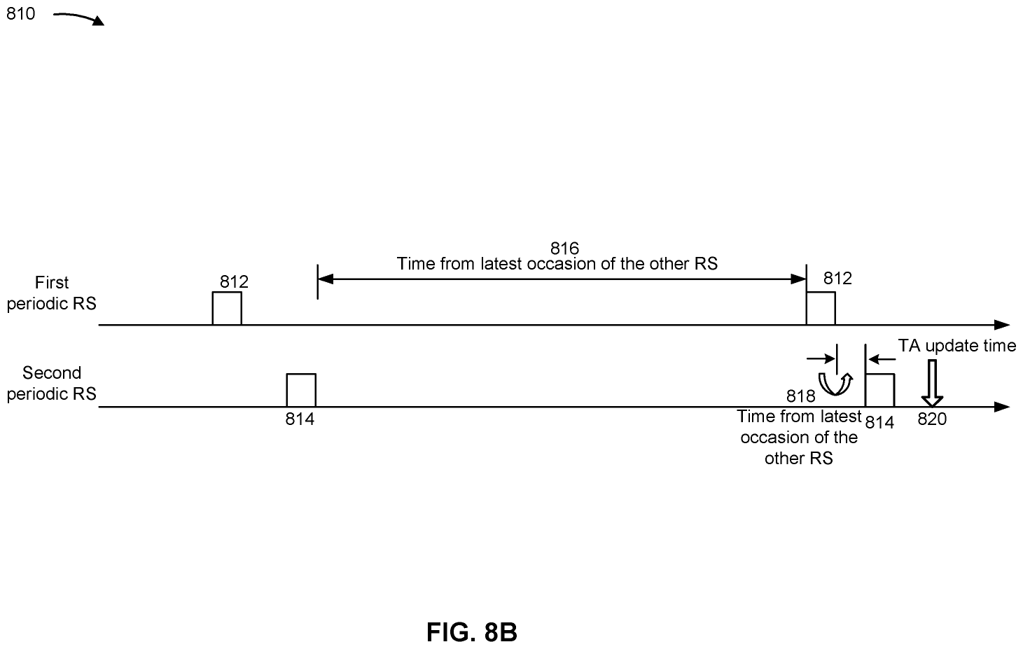

FIGS. 8A-8B are diagrams illustrating examples 800 and 810 associated with implicit TA updates for a deactivated cell or TAG, in accordance with the present disclosure. In FIGS. 8A and 8B, examples 800 and 810 are examples of periodic updating the TA of a deactivated TAG. In some aspects, a UE (e.g., UE 120) may periodically update the TA derived for a deactivated TAG in TA update occasions associated with a periodicity. In this case, the UE may periodically measure the downlink Rx timing difference between the reference active cell and the reference deactivated cell included in the deactivated TAG, and the UE may periodically derive the TA for the deactivated TAG, in the TA update occasions, based at least in part on the periodic downlink Rx timing difference measurements. In some aspects, the UE may determine the periodicity associated with the TA update occasions and a time at which to perform the TA update (e.g., the TA derivation) within each period. For example, the UE may perform a rule-based determination of the periodicity and the time for performing the TA update. In this way, the UE may update the TA for the deactivated TAG with sufficient frequency such that a most recently updated TA derived for the deactivated TAG may be applied to uplink communications on a cell in the deactivated TAG once the cell and/or the deactivated TAG is activated. Furthermore, in some aspects, the rule-based determination of periodicity and the time for performing the TA update may allow a network node to determine whether to schedule an on-demand TA update upon cell activation of one or more cells in the deactivated TAG (e.g., if the time between the latest TA update and the activation of the one or more cells in the deactivated TAG exceeds a threshold), as described elsewhere herein.

In some aspects, the implicit TA update (e.g., in an update occasion) may be restricted to a downlink synchronized case, in which the downlink transmission and/or reception timing difference of any two cells is small (e.g., below a tight threshold, such as 3 μs). In some aspects, such a restriction on performing the implicit TA update may be applied at least when the downlink transmission and/or reception timing per cell or the downlink transmission and/or reception timing difference of two cells cannot be known by a network node and/or the UE.

As shown in FIG. 8A, in some aspects, the UE may measure the downlink Rx timing difference between a first cell (e.g., the reference active cell) and a second cell (e.g., the reference deactivated cell) based at least in part on reference signals in periodic reference signal sets associated with the first and second cells. That is, the UE may measure the downlink Rx timing difference between a first reference signal in a first periodic reference signal set 802 associated with the first cell (e.g., the reference active cell) and a second reference signal in a second periodic reference signal set 804 associated with the second cell (e.g., the reference deactivated cell). For example, the first periodic reference signal set 802 may be an SSB burst set or another periodic reference signal set associated with the first cell, and the second periodic reference signal set 804 may be an SSB burst set or another periodic reference signal set associated with the second cell. In some aspects, the reference signals selected for the downlink Rx timing difference measurement (e.g., the first and second reference signals) may be the strongest reference signals in the respective periodic reference signals sets. For example, the first reference signal may be the strongest reference signal in the first periodic reference signal set 802, and the second reference signal may be the strongest reference signal in the second periodic reference signal set 804.

As shown in FIG. 8A, the first periodic reference signal set 802 may have a first periodicity (P1), and the second periodic reference signal set 804 may have a second periodicity (P2). In addition, the downlink reference signals included in the first and second periodic reference signal sets 802 and 804 may be scheduled at different times. In some aspects, the TA update period (e.g., the periodicity associated with the periodic TA update occasions) may be based at least in part on at least one of the first periodicity (P1) or the second periodicity (P2). For example, as shown in FIG. 8A, the periodicity associated with the periodic TA update occasions may be equal to the longer periodicity (e.g., P1 in FIG. 8A) of the first periodicity (P1) and the second periodicity (P2). Alternatively, the periodicity associated with the periodic TA update occasions may be equal to the shorter periodicity of the first periodicity (P1) and the second periodicity (P2).

In some aspects, in a case in which the periodicity associated with the TA update occasion is equal to a periodicity (e.g., P1 or P2) associated with one of the first or second periodic reference signal sets 802 or 804, the TA update occasions may occur at a time offset (e.g., Xms or symbols) after a last reference signal in the corresponding reference signal set 802 or 804 with the same periodicity as the TA update occasions. For example, as shown in FIG. 8A, and by reference number 806, in a case in which the periodicity of the TA update occasions is equal to P1, a TA update occasion may occur at an offset (e.g., Xms or symbols) after the last reference signal in the first periodic reference signal set 802. Alternatively, in a case in which the periodicity of the TA update occasions is equal to P2, a TA update occasion may occur at an offset (e.g., Xms or symbols) after the last reference signal in the second periodic reference signal set 804. In each TA update occasion, the UE may derive the TA for the deactivated TAG based at least in part on the downlink Rx timing difference measured between the first reference signal (in the first periodic reference signal set 802) and the second reference signal (in the second periodic reference signal set 804). In some aspects, in a TA update occasion, the UE may derive the TA for the deactivated TAG based at least in part on the latest Rx timing difference measured by the end of each TA update period.

In some aspects, instead of using rule-based determination of the TA update periodicity and/or the time, in the TA update period, for the TA update occasion (e.g., based at least in part on P1 and/or P2), the TA update periodicity and/or the time for the TA update occasion may be explicitly signaled to the UE by a network node. For example, the network node may transmit, and the UE may receive (e.g., via an RRC message, a MAC-CE, or DCI), an indication of the TA update periodicity and/or the time for the TA update occasion.

In some aspects, the UE may measure the downlink Rx timing difference between a first cell (e.g., the reference active cell) and a second cell (e.g., the reference deactivated cell) based at least in part on periodic reference signals associated with the first and second cells. That is, the UE may measure the downlink Rx timing difference between a first periodic reference signal associated with the first cell (e.g., the reference active cell) and a second periodic reference signal associated with the second cell (e.g., the reference deactivated cell). This may be similar to the example described in connection with FIG. 8A, in a case in which there is one reference signal per periodic reference signal set. In this case, the first periodic reference signal may have a first periodicity (P1), and the second periodic reference signal may have a second periodicity (P2). In some aspects, the TA update period (e.g., the periodicity associated with the periodic TA update occasions) may be based at least in part on at least one of the first periodicity (P1) or the second periodicity (P2). For example, the periodicity associated with the periodic TA update occasions may be equal to the longer periodicity or the shorter periodicity of the first periodicity (P1) and the second periodicity (P2).

In some aspects, in a case in which the periodicity of the TA update occasions is equal to P1, the TA update occasions may occur at an offset (e.g., Xms or symbols) after the first periodic reference signal. Alternatively, in a case in which the periodicity of the TA update occasions is equal to P2, the TA update occasions may occur at an offset (e.g., Xms or symbols) after the second periodic reference signal.

As shown in FIG. 8B, in some aspects, the UE may measure the downlink Rx timing difference between a first periodic reference signal 812 associated with a first cell (e.g., the reference active cell) and a second periodic reference signal 814 associated with a second cell (e.g., the reference deactivated cell), and the first and second periodic reference signals may have the same periodicity. For example, a first periodicity (P1) of the first periodic reference signal 812 may be equal to a second periodicity (P2) of the second periodic reference signal 814. In this case, the periodicity of the TA update occasions may be equal to the periodicity of the first and second periodic reference signals 812 and 814 (e.g., the periodicity of the TA update occasions may be equal to P1 and P2).

In some aspects, in a case in which the first and second periodic reference signals 812 and 814 have the same periodicity, the TA update occasions may occur at a time offset (e.g., Xms or symbols) after occasions of at least one of the first periodic reference signal 812 or the second periodic reference signal 814. In some aspects, a network node may transmit, and the UE may receive (e.g., via an RRC message, a MAC-CE or DCI), an indication of the reference signal, of the first periodic reference signal 812 or the second periodic reference signal 814, from which the TA update occasions are offset. In some aspects, the UE may perform a rule-based determination/selection of at least one of the first periodic reference signal 812 or the second periodic reference signal 814 from which the TA update occasions are offset. For example, in some aspects, the TA update occasions may occur at an offset (e.g., X ms or symbols) after occasions of the reference signal with a lower or higher resource ID, a lower or higher resource set ID, or a lower or higher associate cell ID, among the first and second periodic reference signals 812 and 814. In some aspects, the TA update occasions may be offset from the reference signal, of the first periodic reference signal 812 and the second periodic reference signal 814, with a shorter distance/duration (in time) between a latest occasion of the other reference signal and an occasion of that reference signal. For example, as shown in FIG. 8B, an amount of time 816 from a latest occasion of the second periodic reference signal 814 to an occasion of the first periodic reference signal 812 may be greater than an amount of time 818 from a latest occasion of the first periodic reference signal 812 to an occasion of the second periodic reference signal 814. In this case, as shown by reference number 820, a TA update occasion may occur at a time offset after the second periodic reference signal 814.

In some aspects, the UE may periodically measure the Rx timing difference in periodically occurring measurement occasions, and the measured Rx timing difference may be filtered across multiple measurement occasions. For example, in a TA update occasion, the UE may derive the TA for the deactivated TAG based at least in part on filtered measurements of the downlink Rx timing difference in multiple measurement occasions. In some aspects, filter coefficients for filtering the measurements of the downlink Rx timing difference may be determined, by the UE, based at least in part on a rule, or the filter coefficients may be signaled to the UE by a network node (e.g., via an RRC message, a MAC-CE, or DCI). In some aspects, the derived TA for the deactivated TAG may be filtered across multiple TA update occasions. For example, in a TA update occasion, the UE may derive the TA for the deactivated TAG based at least in part on filtered TAs for the deactivated TAG derived in one or more previous TA update occasions. In some aspects, filter coefficients for filtering the TAs derived in the one or more previous TA update occasions and a TA derived in a current TA update occasion may be determined, by the UE, based at least in part on a rule, or the filter coefficients may be signaled to the UE by a network node (e.g., via an RRC message, a MAC-CE, or DCI).

As indicated above, FIGS. 8A-8B are provided as examples. Other examples may differ from what is described with respect to FIGS. 8A-8B.

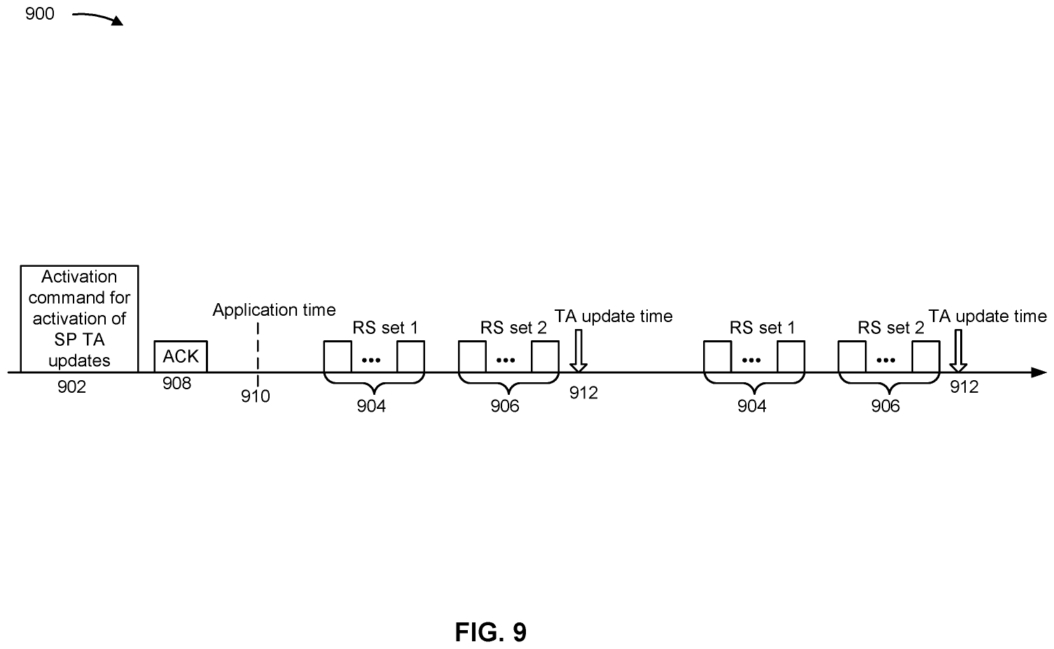

FIG. 9 is a diagram illustrating an example 900 associated with implicit TA updates for a deactivated cell or TAG, in accordance with the present disclosure. As shown in FIG. 9, example 900 shows an example of activation of semi-persistent scheduled TA update occasions for a deactivated TAG. In some aspects, a network node may dynamically activate and deactivate semi-persistent TA updates for one or more deactivated cells or TAGs via MAC-CE or DCI. For example, the network node may deactivate and/or activate semi-persistent TA updates for one or more deactivated cells or TAGs based at least in part on a UE capability (e.g., indicated in a UE capability report) for a maximum quantity of deactivated TAGs for which TA derivation is supported.

As shown in FIG. 9, and by reference number 902, a network node may transmit, and a UE (e.g., UE 120) may receive, an activation command that activates semi-persistent TA update occasions for a deactivated TAG. For example, the activation command may be included in a MAC-CE or DCI. The activation command may include an indication of a cell ID or a TAG ID that identifies the deactivated cell or deactivated TAG (or multiple deactivated cells or TAGs) for which to activate the semi-persistent TA updates. In some aspects, for each deactivated cell/TAG ID, the activated measurement reference signals from both the reference active and deactivated cells may be pre-configured or determined by a rule. In some aspects, each deactivated cell/TAG may be associated with multiple configured measurement configurations, and the activation command may include a respective indication, for each deactivated TAG (or deactivated cell) for which semi-persistent TA updates are activated, of a measurement configuration, of the multiple configured measurement configurations associated with the deactivated TAG (or deactivated cell). A measurement configuration may indicate the reference signals and/or BWPs for measuring the downlink Rx timing difference. For example, as shown in FIG. 9, the measurement configuration for semi-persistent TA updates for a deactivated TAG may indicate a first reference signal set 904 associated with a reference active cell and a second reference signal set 906 associated with a reference deactivated cell included in the deactivated TAG. In some aspects, the network node may transmit, and the UE may receive, a deactivation command (e.g., via a MAC-CE or DCI) that indicates deactivation of semi-persistent TA updates for one or more deactivated TAGs (or deactivated cells). In this case, the deactivation command may indicate one or more TAG IDs (or cell IDs) that identify the one or more deactivated TAGs (or deactivated cells) for which the semi-persistent TA updates are to be deactivated.

As shown in FIG. 9, and by reference number 908, the UE may transmit, to the network node, an acknowledgement (ACK) for the activation command (or for a deactivation command). As shown by reference number 910, the activation of the semi-persistent TA update occasions by the activation command may occur at an application time. Similarly, in the case in which a deactivation command is received by the UE, the deactivation of the semi-persistent TA occasions by the deactivation command may occur at the application time. In some aspects, the application time may be associated with a time offset from an end of the ACK for the activation command or the application time may be associated with a time offset from the activation command. For example, in some aspects, the application time may be Xms from the end of the ACK for the activation command, Xms from the slot carrying the ACK for the activation command, or Xms from the activation command. In this case, X may be defined based at least in part on a UE capability or defined in a wireless communication standard. In some aspects, the application time may occur atX symbols, or at a start of a first slot after X symbols, from the end of the ACK for the activation command or from the activation command. In this case, the SCS of the X symbols may be a function of the SCS of the activation command (or deactivation command) and the SCSs for all measured reference signal sets, including in a case when the activation/deactivation command indicates multiple deactivated cell/TAG IDs. For example, the SCS of the X symbols may be the largest SCS of all measured reference signals for all indicated deactivated (or activated) cell/TAG ID(s). In some aspects, the X symbols may be defined based at least in part on a UE capability or defined in a wireless communication standard.

As shown in FIG. 9, and by reference number 912, after the application time, semi-persistent TA update occasions may be activated. After the application time, the UE may measure the Rx timing difference between a first reference signal in the first reference signal set 904 and a second reference signal in the second reference signal set 906, and the UE may derive the TA for a deactivated TAG, in each TA update occasion, based at least in part on the latest Rx timing difference measurements.

As indicated above, FIG. 9 is provided as an example. Other examples may differ from what is described with respect to FIG. 9.

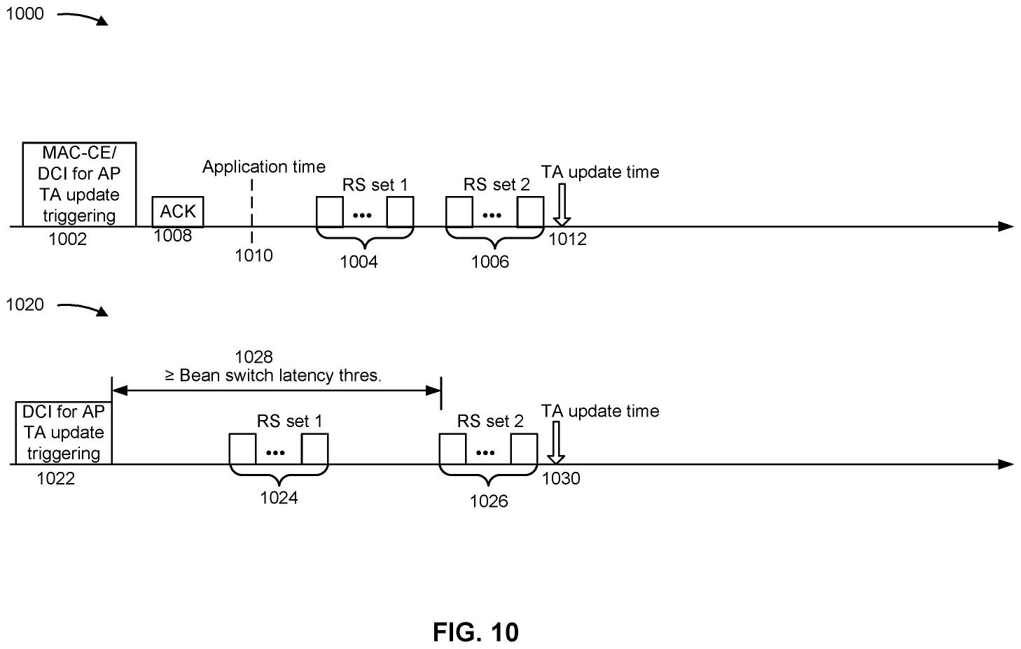

FIG. 10 is a diagram illustrating examples 1000 and 1020 associated with implicit TA updates for a deactivated cell or TAG, in accordance with the present disclosure. As shown in FIG. 10, examples 1000 and 1020 show examples of triggering aperiodic TA updates for a deactivated TAG. In some aspects, a network node may dynamically trigger an aperiodic (e.g., a one-time) TA update for one or more deactivated cells or TAGs via MAC-CE or DCI.

As shown in example 1000, and by reference number 1002, a network node may transmit, and a UE (e.g., UE 120) may receive, an indication for triggering an aperiodic TA update for a deactivated TAG. For example, the indication for triggering the aperiodic TA update may be included in a MAC-CE or DCI. The indication for triggering the aperiodic TA update may indicate a cell ID or a TAG ID that identifies the deactivated cell or deactivated TAG (or multiple cell/TAG IDs that indicate multiple deactivated cells/TAGs) for which the aperiodic TA update is triggered. In some aspects, the indication for triggering the aperiodic TA update may include an indication, for a deactivated TAG (or deactivated cell), of a measurement configuration, of multiple configured measurement configurations associated with the deactivated TAG (or deactivated cell). The measurement configuration may indicate the reference signals and/or BWPs for measuring the downlink Rx timing difference for the aperiodic TA update. For example, as shown in example 1000, the measurement configuration for the deactivated TAG may indicate a first reference signal set 1004 associated with a reference active cell and a second reference signal set 1006 associated with a reference deactivated cell included in the deactivated TAG.

As shown in example 1000, and by reference number 1008, in some aspects, the UE may transmit, to the network node, an ACK for the indication for triggering the aperiodic TA update. As shown by reference number 1010, an application time may be associated with triggering the aperiodic TA update. In some aspects, the application time may be associated with a time offset from an end of the ACK for the indication for triggering the aperiodic TA update, or the application time may be associated with a time offset from the indication for triggering the aperiodic TA update. For example, in some aspects, the application time may be Xms from the end of the ACK, Xms from the slot carrying the ACK, or X ms from the indication for triggering the aperiodic TA update. In this case, X may be defined based at least in part on a UE capability or defined in a wireless communication standard. In some aspects, the application time may occur at X symbols, or at a start of a first slot after X symbols, from the end of the ACK or from the indication for triggering the aperiodic TA update. In this case, the X symbols may be defined based at least in part on a UE capability or defined in a wireless communication standard.

As shown in example 1000, and by reference number 1012, a TA update time for the aperiodic TA update (e.g., a time at which the TA derivation for the deactivated TAG is performed) may be after an occurrence of the first reference signal set 1004 and an occurrence of the second reference signal set 1006, after the application time. After the application time, the UE may measure the Rx timing difference between a first reference signal in the first reference signal set 1004 and a second reference signal in the second reference signal set 1006, and the UE may derive the TA for the deactivated TAG based at least in part on the latest Rx timing difference measurement.

As shown in example 1020, and by reference number 1022, a network node may transmit, and a UE (e.g., UE 120) may receive, DCI including an indication for triggering an aperiodic TA update for a deactivated TAG. The indication for triggering the aperiodic TA update may indicate a cell ID or a TAG ID that identifies the deactivated cell or deactivated TAG (or multiple cell/TAG IDs that indicate multiple deactivated cells/TAGs) for which the aperiodic TA update is triggered. In some aspects, the indication for triggering the aperiodic TA update may include an indication, for a deactivated TAG (or deactivated cell), of a measurement configuration, of multiple configured measurement configurations associated with the deactivated TAG (or deactivated cell). The measurement configuration may indicate the reference signals and/or BWPs for measuring the downlink Rx timing difference for the aperiodic TA update. For example, as shown in example 1020, the measurement configuration for the deactivated TAG may indicate a first reference signal set 1024 associated with a reference active cell and a second reference signal set 1026 associated with a reference deactivated cell included in the deactivated TAG.

In some aspects, in the case of an aperiodic TA update triggered by an indication in DCI, there may not be a corresponding ACK and application time for the DCI. In some aspects, in a case in which there is no corresponding ACK and application time for DCI that triggers the aperiodic TA update, a measured reference signal triggered by the DCI may have a scheduling offset that is greater than a beam switch latency threshold if the Rx beam for the UE to receive the reference signal is different from a current default Rx beam for the UE. For example, in example 1020, the Rx beam for receiving the second reference signal set 1006 on the reference deactivated cell in the deactivated TAG may be different from the default beam on the active cell, for the UE. In this case, as shown by reference number 1028, the scheduling offset for the second reference signal set 1006 (e.g., the offset between the DCI and the second reference signal set 1006) on the reference deactivated cell may be greater than the beam switch latency threshold. As shown in example 1020, and by reference number 1030, the TA update time for the aperiodic TA update (e.g., the time at which the TA derivation for the deactivated TAG is performed) may be after the first reference signal set 1024 and the second reference signal set 1026. The UE may measure the Rx timing difference between a first reference signal in the first reference signal set 1024 and a second reference signal in the second reference signal set 1026, and the UE may derive the TA for the deactivated TAG based at least in part on the latest Rx timing difference measurement.

As indicated above, FIG. 10 is provided as an example. Other examples may differ from what is described with respect to FIG. 10.

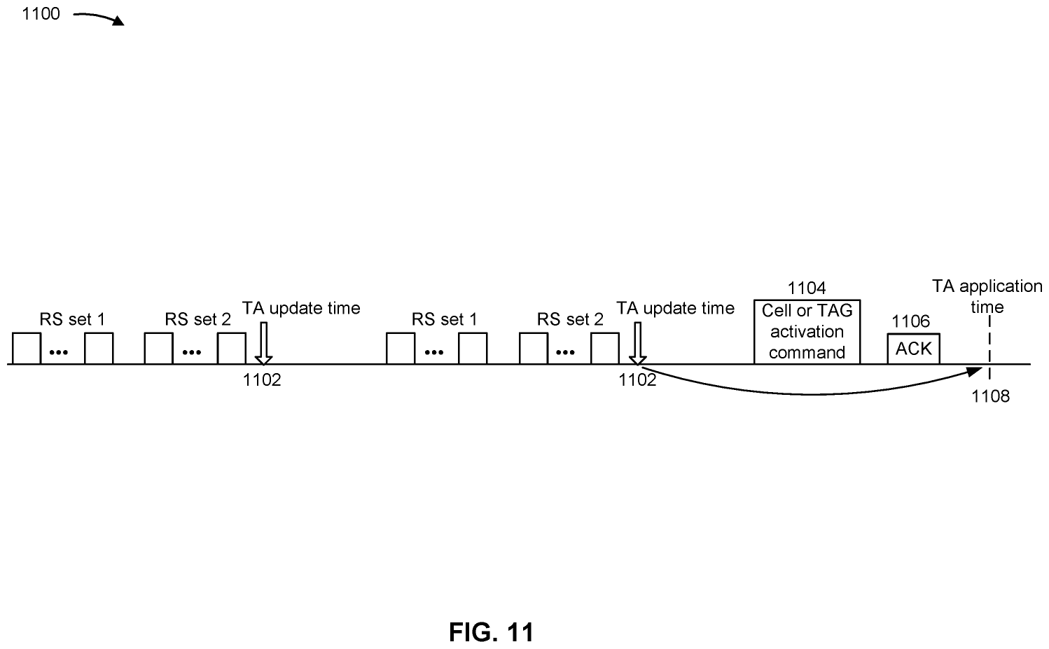

FIG. 11 is a diagram illustrating an example 1100 associated with implicit TA updates for a deactivated cell or TAG, in accordance with the present disclosure. As shown in FIG. 11, example 1100 shows an example of activation of a previously deactivated cell or TAG.

As shown in FIG. 11, and by reference number 1102, a UE (e.g., UE 120) may perform one or more TA updates for a deactivated TAG based on measurements of the downlink Rx timing difference between a first reference signal in a first reference signal set (RS set 1) and a second reference signal in a second reference signal set (RS set 2). As shown by reference number 1104, a network node may transmit, and the UE may receive, a cell or TAG activation command that indicates activation of one or more cells in the deactivated TAG for which the TA updates are performed by the UE. For example, the cell or TAG activation command may be included in a MAC-CE or DCI. As shown by reference number 1106, the UE may transmit, to the network node, an ACK for the cell or TAG activation command. As shown by reference number 1108, a TA application time may be associated with the cell or TAG activation command. In some aspects, the TA application time may be associated with a time offset from the ACK for the cell or TAG activation command, or the TA application time may be associated with a time offset from the cell or TAG activation command. For example, in some aspects, the TA application time may be Xms from the end of the ACK for the cell or TAG activation command, Xms from the slot carrying the ACK for the cell or TAG activation command, or X ms from the cell or TAG activation command. In this case, X may be defined based at least in part on a UE capability or defined in a wireless communication standard. In some aspects, the TA application time may occur at X symbols, or at a start of a first slot after X symbols, from the end of the ACK for the cell or TAG activation command or from the cell or TAG activation command. In this case, the SCS of the X symbols may be a function of the SCS of the cell or TAG activation command (e.g., the MAC-CE or DCI) and the SCSs of all active or configured BWPs of the activated cell(s) or configured cell(s) in the activated TAG. For example, the SCS of the X symbols may be the largest SCS among all of the active BWPs of the activated cell(s) in the activated TAG. In some aspects, the X symbols may be defined based at least in part on a UE capability or defined in a wireless communication standard.

In some aspects, the one or more cells in the previously deactivated TAG may be activated by the cell or TAG activation command at the TA application time. In some aspects, once the one or more cells in the previously deactivated TAG are activated (e.g., after the application time), the UE may apply the latest updated TA (e.g., the TA derived for the previously deactivated TAG at the latest TA update time prior to the TA application time) to all active cells in the same TAG as the activated cell/TAG (e.g., the previously deactivated cell). For example, the UE may apply the latest TA update to one or more uplink communications transmitted by the UE on one or more of the cells in the previously deactivated TAG. In some aspects, after the TA application time, the UE may use an activated cell as a network entity SpCell, or the UE may use the activated TAG as a new pTAG.

As indicated above, FIG. 11 is provided as an example. Other examples may differ from what is described with respect to FIG. 11.

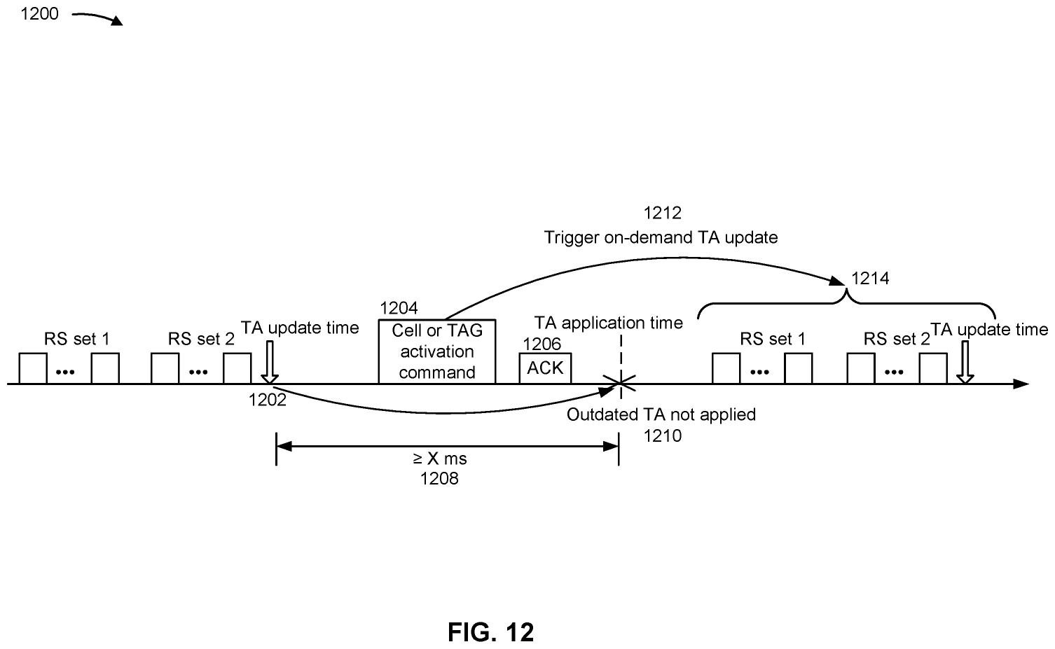

FIG. 12 is a diagram illustrating an example 1200 associated with implicit TA updates for a deactivated cell or TAG, in accordance with the present disclosure. As shown in FIG. 12, example 1200 shows an example of an on-time TA update for a deactivated TAG in connection with activation of one or more cells in the deactivated TAG.

As shown in FIG. 12, and by reference number 1202, a UE (e.g., UE 120) may perform one or more TA updates for a deactivated TAG based on measurements of the downlink Rx timing difference between a first reference signal in a first reference signal set (RS set 1) and a second reference signal in a second reference signal set (RS set 2).

As shown by reference number 1204, a network node may transmit, and the UE may receive, a cell or TAG activation command that indicates activation of one or more cells in the deactivated TAG for which the TA updates are performed by the UE. For example, the cell or TAG activation command may be included in a MAC-CE or DCI. As shown by reference number 1206, the UE may transmit, to the network node, an ACK for the cell or TAG activation command.

In some aspects, in connection with the activation of the deactivated cell or TAG, the network node may determine whether to allow the UE to apply the latest updated TA for the deactivated TAG based at least in part on a time duration between the latest TA update time and the TA application time associated with the cell or TAG activation command. For example, as shown by reference number 1208, the network node may determine whether the time duration between the latest TA update time for the deactivated cell and the TA application time satisfies a threshold (e.g., is greater than or equal to Xms). In some aspects, based at least in part on a determination of whether the time duration between the latest TA update time and the TA application time satisfies the threshold, the network node may indicate, to the UE, whether the UE is to apply the latest TA update at the application time. For example, the network node may indicate whether the UE is to apply the latest TA update to the newly activated cell/TAG in the cell or TAG activation command. As shown by reference number 1210, in connection with a determination that the time duration between the latest TA update time and the TA application time satisfies the threshold (e.g., is greater than or equal to Xms), the network node may indicate, to the UE, not to apply the latest TA update at the application time. In some aspects, the indication not to apply the latest TA update at the TA application time may be an explicit indication included in the cell or TAG activation command. In some aspects, the indication not to apply the latest TA update at the TA application time associated with the cell or TAG activation command may be an implicit indication provided by an indication, included in the cell or TAG activation command, for triggering an on-demand TA update. For example, the UE may not apply the latest TA update in a case in which the cell or TAG activation command includes an indication for triggering an on-demand TA update for the cell/TAG to be activated.

As shown by reference number 1212, the cell or TAG activation command may trigger an on-demand TA update to be performed by the UE. For example, the cell or TAG activation command may include an indication for triggering the on-demand TA update for the TAG to be activated in connection with the determination, by the network node, that the time duration between the latest TA update time and the TA application time satisfies the threshold (e.g., is greater than or equal to Xms). As shown by reference number 1214, the UE, in connection with receiving the cell or TAG activation command that includes the indication for triggering the on-demand TA update, may perform the on-demand TA update for the TAG to be activated. For example, the UE may measure the downlink Rx timing difference between a first reference signal in RS set 1 and a second reference signal in RS set 2, and the UE may derive the TA for the TAG to be activated based at least in part on downlink Rx timing difference measurement. In some aspects, after the UE performs the on-demand TA update for a TAG, the UE may apply the TA derived in the on-demand TA update for one or more uplink communications on one or more active cells on the TAG (e.g., one or more cells activated by the cell or TAG activation command).

As indicated above, FIG. 12 is provided as an example. Other examples may differ from what is described with respect to FIG. 12.

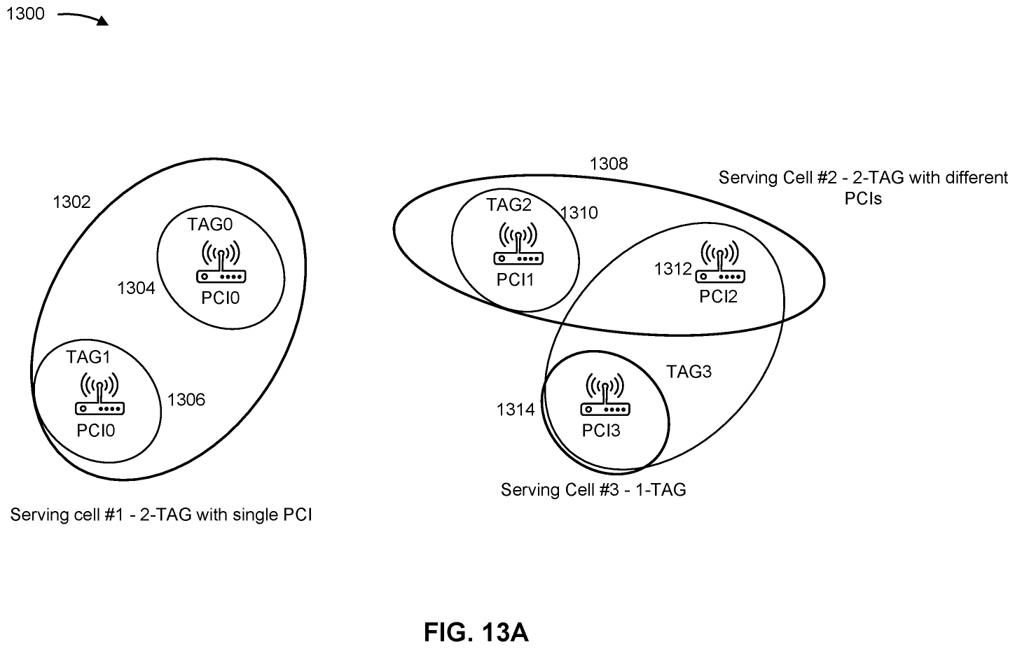

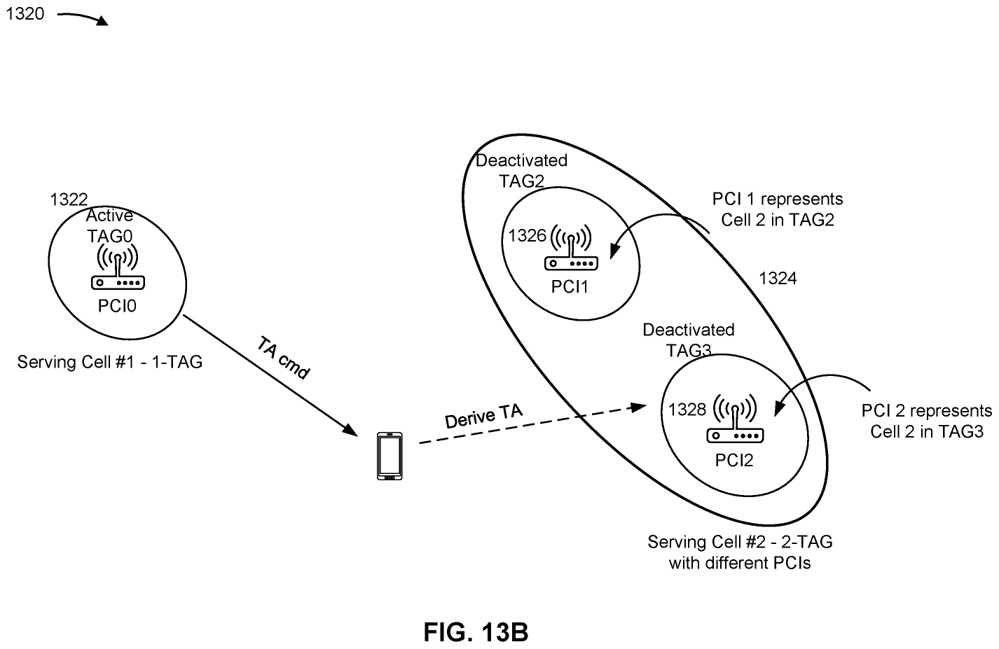

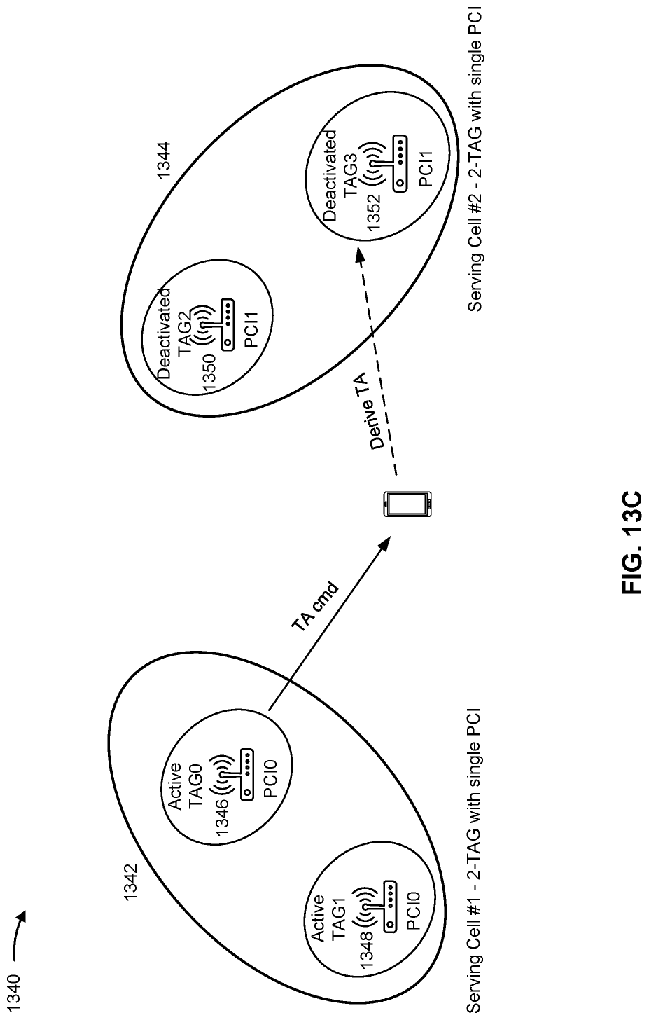

FIGS. 13A-13C are diagrams illustrating examples 1300, 1320, and 1340 associated with implicit TA updates for a deactivated cell or TAG, in accordance with the present disclosure. As shown in FIGS. 13A-13C, examples 1300, 1320, and 1340 show examples of serving cells that include two transmit receive points (TRPs) with different TAGs. For example, a serving cell may have two TRPs with different TAGs to address largely different propagation delays from the two TRPs.

As shown in FIG. 13A, and by reference number 1302, a first serving cell includes two TRPs 1304 and 1306 with different TAGs (TAG0 and TAG1, respectively) that have the same PCI (PCI0) as the serving cell PCI. As shown by reference number 1308, a second serving cell includes two TRPs 1310 and 1312 with different TAGs (TAG2 and TAG3, respectively) and two different PCIs. For example, TRP 1310 may be associated with PCI1, and TRP 1312 may be associated with PCI2. In this case, the two different PCIs may include the serving cell PCL (e.g., PCI1) and an additional PCI (e.g., PCI2). As shown by reference number 1314, a third serving cell may be a one-TAG serving cell associated with PCI3 and TAG3.

As shown in FIG. 13B, example 1320 includes a first serving cell 1322 that is a one-TAG serving cell with TAG0 and PCI0, and a second serving cell 1324 with two PCIs. For example, the second serving cell 1324 includes a TRP 1326 associated with TAG2 and PCI1 and a TRP 1328 associated with TAG3 and PCI2. For example, TAG0 may be an active TAG, TAG2 may be a deactivated TAG, and TAG3 may be a deactivated TAG. As shown in FIG. 13B, in some aspects, a UE 120 may receive, on the first serving cell 1322, a TA command that indicates the TA for the active TAG0, and the UE 120 may derive the TA for deactivated TAG3. In some aspects, for a two-TAG cell with two PCIs, the UE 120 may perform the TA derivation based at least in part on the pair of active and deactivated TAGs as described above, with an additional clarification. In this case, the “cell” in a TAG may refer to a one-TAG serving cell or a two-TAG serving cell with corresponding PCI in the TAG. For example, PCI2 may uniquely represent the second serving cell 1324 in TAG 3. In some aspects, to derive the TA for the deactivated TAG3, the UE 120 may use the downlink Rx timing measured from a downlink reference signal associated with PCI2 in TAG3, instead of PCI1 in TAG2.

As shown in FIG. 13C, example 1340 includes a first serving cell 1342 that is a two-TAG serving cell with a single PCI and a second serving cell 1344 that is a two-TAG serving cell with single PCI. For example, the first serving cell 1342 includes TRP 1346 associated with TAG0 and PCI0 and TRP 1348 associated with TAG1 and PCI0, and the second serving cell 1344 includes TRP 1350 associated with TAG2 and PCI1 and TRP 1352 associated with TAG3 and PCI1. As shown in FIG. 13C, TAG0 and TAG1 may be active TAGs for a UE 120, and TAG2 and TAG3 may be deactivated TAGS for the UE 120. In some aspects, the UE 120 may receive, from TRP 1346, a TA command that indicates a TA for active TAG0, and the UE 120 may derive a TA for deactivated TAG3. In some aspects, at least for a multi-TAG cell with single PCI, a TRP ID may be associated with a downlink reference signal, and the UE 120 may identify two downlink reference signals transmitted by two TRPs associated with the intended active and deactivated TAGs, respectively, to use to perform the corresponding DL Rx timing difference and, hence, to derive the TA for the deactivated TAG. In this case, the TRP ID may be a new ID used to identify the TRPs, or the TRP may be an existing ID, such as a TAG ID or a control resource set (CORESET) pool index. The downlink reference signals may include SSBs and/or CSI-RSs, which may have SSBs as quasi co-location (QCL) source reference signals. For example, SSBs 1-10 may be associated with CORESET pool index 0 (e.g., associated with a first TRP in a serving cell), and SSBs 11-20 may be associated with CORESET pool index 1 (e.g., associated with a second TRP in the serving cell). In some aspects, the UE 120 may measure the downlink Rx timing difference between a first reference signal associated with a first TRP ID associated with TRP 1346 (e.g., the TRP associated with the active TAG0) and a second reference signal associated with TRP 1352 (e.g., the TRP associated with the deactivated TAG3).

In some aspects, in case of TA derivation involving a multi-TAG cell, only one TAG per cell may be considered as the active or deactivated TAG for downlink Rx timing difference measurement and the TA derivation. In some aspects, for a multi-TAG cell with a single PCI, only the TAG associated with a primary TRP (e.g., identified by CORESET pool index 0) may be considered as the active TAG or the deactivated TAG. In some aspects, for a multi-TAG cell with two PCIs, only the TAG associated with a primary TRP (e.g., identified by the serving cell PCI) may be considered as the active TAG or the deactivated TAG. In this case, the UE 120 may only transmit uplink communications, using the derived TA, to the primary TRP in the multi-TAG cell upon activation of the cell.

As indicated above, FIGS. 13A-13C are provided as examples. Other examples may differ from what is described with respect to FIGS. 13A-13C.

Some aspects described herein may be extended to be used in other scenarios and/or use cases, in addition to the implicit TA derivation for a deactivated TAG. In some aspects, the downlink Rx timing difference measurement described herein may be used for a report based TA update for L1/L2 mobility. For example, a UE may measure the Rx timing difference between a reference active cell in an active TAG and a reference deactivated cell in a deactivated TAG, and the UE may transmit, to a network node, a report including an indication of the Rx timing difference measurement. The network node may determine the TA for the deactivated TAG for the UE, and the network node may transmit, to the UE, an indication of the TA for the deactivated TAG.

In some aspects, the derivation of the TA described herein may be further applied for multiple DCI (mDCI) multiple TRP (mTRP) with per TRP/cell TA. For example, the UE may perform the TA derivation for L1/L2 mobility for one of two TRPs with associated different CORESET pool indexes or PCIs configured under the same active serving cell. In this case, instead of the implicit TA update for the deactivated TAG based at least in part on a pair of active/deactivated TAGs in the L1/L2 mobility, the two entities participating in the implicit TA update may be different.

FIG. 14 is a diagram illustrating an example process 1400 performed, for example, by a UE, in accordance with the present disclosure. Example process 1400 is an example where the UE (e.g., UE 120) performs operations associated with implicit timing advance updates for a deactivated cell or TAG.

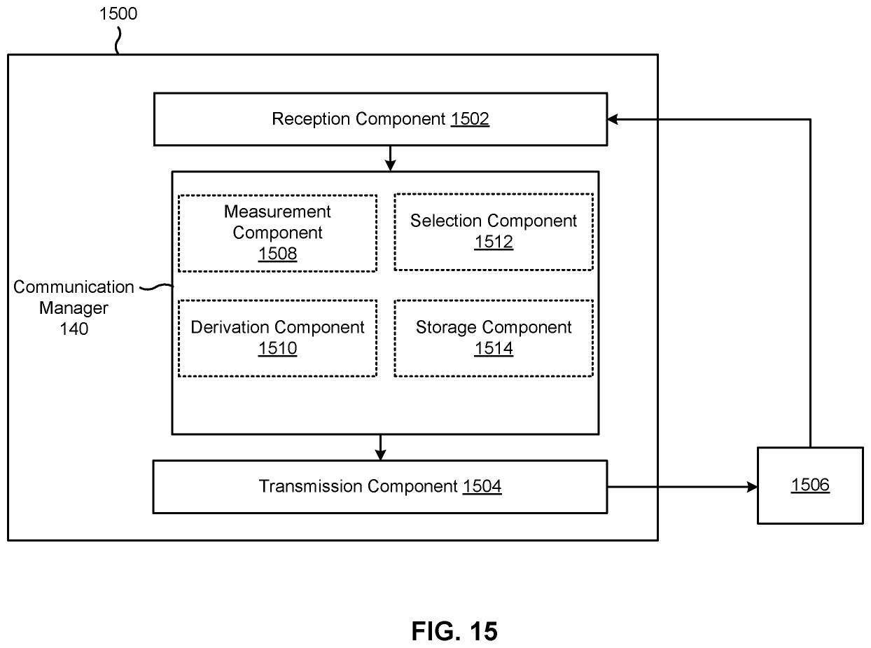

As shown in FIG. 14, in some aspects, process 1400 may include measuring a downlink reception timing difference between a reference active cell in a first TAG and a reference deactivated cell in a second TAG, wherein the second TAG is a deactivated TAG (block 1410). For example, the UE (e.g., using communication manager 140 and/or measurement component 1508, depicted in FIG. 15) may measure a downlink reception timing difference between a reference active cell in a first TAG and a reference deactivated cell in a second TAG, wherein the second TAG is a deactivated TAG, as described above.

As further shown in FIG. 14, in some aspects, process 1400 may include deriving a timing advance for the second TAG based at least in part on a timing advance for the first TAG and the downlink reception timing difference between the reference active cell and the reference deactivated cell (block 1420). For example, the UE (e.g., using communication manager 140 and/or derivation component 1510, depicted in FIG. 15) may derive a timing advance for the second TAG based at least in part on a timing advance for the first TAG and the downlink reception timing difference between the reference active cell and the reference deactivated cell, as described above.

As further shown in FIG. 14, in some aspects, process 1400 may include transmitting, on one or more cells in the second TAG, one or more uplink communications using the timing advance for the second TAG, in connection with activation of the one or more cells in the second TAG (block 1430). For example, the UE (e.g., using communication manager 140 and/or transmission component 1504, depicted in FIG. 15) may transmit, on one or more cells in the second TAG, one or more uplink communications using the timing advance for the second TAG, in connection with activation of the one or more cells in the second TAG, as described above.

Process 1400 may include additional aspects, such as any single aspect or any combination of aspects described below and/or in connection with one or more other processes described elsewhere herein.

In a first aspect, process 1400 includes receiving a timing advance command that includes an indication of the timing advance for the first TAG.

In a second aspect, alone or in combination with the first aspect, the first TAG is a primary TAG, or the first TAG is an active secondary TAG selected, from a set of one or more active secondary TAGs, based at least in part on a TAG identifier.

In a third aspect, alone or in combination with one or more of the first and second aspects, process 1400 includes receiving, from a network node, an indication of a TAG identifier that identifies the first TAG.

In a fourth aspect, alone or in combination with one or more of the first through third aspects, process 1400 includes receiving, from a network node, an indication of a TAG identifier that identifies the second TAG.

In a fifth aspect, alone or in combination with one or more of the first through fourth aspects, process 1400 includes selecting the second TAG from one or more deactivated TAGs that include one or more candidate SpCells.

In a sixth aspect, alone or in combination with one or more of the first through fifth aspects, the reference active cell is an SpCell in the first TAG, and the reference deactivated cell is a candidate SpCell in the second TAG.

In a seventh aspect, alone or in combination with one or more of the first through sixth aspects, process 1400 includes receiving, from a network node, an indication that identifies the reference active cell and the deactivated reference cell.

In an eighth aspect, alone or in combination with one or more of the first through seventh aspects, measuring the downlink reception timing difference includes measuring the downlink reception timing difference based at least in part on a first reference signal in a first BWP associated with the reference active cell and a second reference signal in a second BWP associated with the reference deactivated cell.

In a ninth aspect, alone or in combination with one or more of the first through eighth aspects, the first BWP is an active downlink BWP associated with the reference active cell.

In a tenth aspect, alone or in combination with one or more of the first through ninth aspects, the second BWP is an initial downlink BWP associated with the reference deactivated cell, the second BWP is a downlink BWP with a lowest BWP identifier in a set of downlink BWPs associated with the reference deactivated cell, or the second BWP is a downlink BWP with a highest BWP identifier in the set of downlink BWPs associated with the reference deactivated cell.

In an eleventh aspect, alone or in combination with one or more of the first through tenth aspects, process 1400 includes receiving, from a network node, an indication of a downlink BWP identifier that identifies the second BWP.

In a twelfth aspect, alone or in combination with one or more of the first through eleventh aspects, the first reference signal is a strongest SSB associated with the reference active cell or a downlink reference signal associated with an active or indicated TCI state for the reference active cell, and the second reference signal is a strongest SSB associated with the reference deactivated cell or a downlink reference signal associated with an indicated TCI state for reference deactivated cell.

In a thirteenth aspect, alone or in combination with one or more of the first through twelfth aspects, process 1400 includes receiving, from a network node, an indication of a first reference signal identifier that identifies the first reference signal and a second reference signal identifier that identifies the second reference signal.

In a fourteenth aspect, alone or in combination with one or more of the first through thirteenth aspects, process 1400 includes selecting the first reference signal from a first set of downlink reference signals configured for the reference active cell, and the second reference signal from a second set of downlink reference signals configured for the reference deactivated cell.

In a fifteenth aspect, alone or in combination with one or more of the first through fourteenth aspects, the first reference signal and the second reference signal are associated with a same center frequency and a same sub-carrier spacing.

In a sixteenth aspect, alone or in combination with one or more of the first through fifteenth aspects, deriving the timing advance for the second TAG includes deriving the timing advance for the second TAG in connection with a determination that a first reception quality measurement associated with the first reference signal and a second reception quality measurement associated with the second reference signal satisfy a threshold.

In a seventeenth aspect, alone or in combination with one or more of the first through sixteenth aspects, the reference active cell and the reference deactivated cell operate in a same frequency band, or a difference between a frequency associated with the reference active cell and a frequency associated with the reference deactivated cell satisfies a threshold.

In an eighteenth aspect, alone or in combination with one or more of the first through seventeenth aspects, deriving the timing advance for the second TAG includes deriving the timing advance for the second TAG in connection with at least one of a determination that a downlink transmission timing difference between the reference active cell and the reference deactivated cell satisfies a threshold, or a determination that the downlink reception timing difference between the reference active cell and the reference deactivated cell satisfies a threshold.

In a nineteenth aspect, alone or in combination with one or more of the first through eighteenth aspects, measuring the downlink reception timing difference includes measuring a time difference between reception of first or strongest detected paths of corresponding downlink frames from the reference active cell and the reference deactivated cell.

In a twentieth aspect, alone or in combination with one or more of the first through nineteenth aspects, process 1400 includes receiving, from a network node, timing information relating to a downlink transmission timing difference between the reference active cell and the reference deactivated cell and a difference between uplink and downlink timing gaps in the reference active cell and the reference deactivated cell, wherein deriving the timing advance for the second TAG includes deriving the timing advance for the second TAG based at least in part on a timing advance for the first TAG, the downlink reception timing difference between the reference active cell and the reference deactivated cell, and the timing information.

In a twenty-first aspect, alone or in combination with one or more of the first through twentieth aspects, the timing information includes an indication of a timing offset value based at least in part on the downlink transmission timing difference between the reference active cell and the reference deactivated cell and the difference between the uplink and downlink timing gaps in the reference active cell and the reference deactivated cell.

In a twenty-second aspect, alone or in combination with one or more of the first through twenty-first aspects, the timing information includes at least one of an indication of the downlink transmission timing difference between the reference active cell and the reference deactivated cell, or an indication of an uplink timing difference between the reference active cell and the reference deactivated cell.

In a twenty-third aspect, alone or in combination with one or more of the first through twenty-second aspects, the timing information includes respective indications of downlink frame timings for the reference active cell and the reference deactivated cell, or respective indications of uplink frame timings for the reference active cell and the reference deactivated cell.

In a twenty-fourth aspect, alone or in combination with one or more of the first through twenty-third aspects, deriving the timing advance for the second TAG includes periodically deriving the timing advance for the second TAG in timing advance update occasions associated with a periodicity.

In a twenty-fifth aspect, alone or in combination with one or more of the first through twenty-fourth aspects, measuring the downlink reception timing difference includes measuring the downlink reception timing difference based at least in part on a first reference signal associated with the reference active cell and a second reference signal associated with the reference deactivated cell, wherein the first reference signal is included in a first periodic reference signal set with a first periodicity and the second reference signal is included in a second periodic reference signal set with a second periodicity, and wherein the periodicity associated with the timing advance update occasions is based at least in part on at least one of the first periodicity or the second periodicity.

In a twenty-sixth aspect, alone or in combination with one or more of the first through twenty-fifth aspects, the periodicity associated with the timing advance update occasions is equal to the first periodicity, and the timing advance update occasions occur at a time offset after a last reference signal in the first periodic reference signal set, or the periodicity associated with the timing advance update occasions is equal to the second periodicity, and the timing advance update occasions occur at the time offset after a last reference signal in the second periodic reference signal set.

In a twenty-seventh aspect, alone or in combination with one or more of the first through twenty-sixth aspects, measuring the downlink reception timing difference includes measuring the downlink reception timing difference based at least in part on a first periodic reference signal associated with the reference active cell and a second periodic reference signal associated with the reference deactivated cell, wherein the periodic first reference signal is associated with a first periodicity and the second periodic reference signal is associated with a second periodicity, and wherein the periodicity associated with the timing advance update occasions is based at least in part on at least one of the first periodicity or the second periodicity.

In a twenty-eighth aspect, alone or in combination with one or more of the first through twenty-seventh aspects, the first periodicity is equal to the second periodicity, and the periodicity associated with the timing advance update occasions is equal to the first periodicity and the second periodicity.

In a twenty-ninth aspect, alone or in combination with one or more of the first through twenty-eighth aspects, the timing advance update occasions occur at a time offset after occasions of the first periodic reference signal or after occasions of the second periodic reference signal.

In a thirtieth aspect, alone or in combination with one or more of the first through twenty-ninth aspects, measuring the downlink reception timing difference includes periodically measuring the downlink reception timing difference in measurement occasions, wherein periodically deriving the timing advance for the second TAG includes deriving the timing advance for the second TAG, in a timing advance update occasion, based at least in part on filtered measurements of the downlink reception timing difference in a plurality of measurement occasions.

In a thirty-first aspect, alone or in combination with one or more of the first through thirtieth aspects, periodically deriving the timing advance for the second TAG includes deriving the timing advance for the second TAG, in a timing advance update occasion, based at least in part on filtered timing advances for the second TAG derived in one or more previous timing advance update occasions.

In a thirty-second aspect, alone or in combination with one or more of the first through thirty-first aspects, process 1400 includes transmitting, to a network node, a UE capability report indicating a UE capability for timing advance derivation, wherein the UE capability report indicates at least one of a maximum quantity of deactivated cells or TAGs for which timing advance derivation is supported, one or more time-domain types supported for downlink reception timing difference measurement and timing advance derivation, or a quantity of time-domain types supported simultaneously for a deactivated TAG.

In a thirty-third aspect, alone or in combination with one or more of the first through thirty-second aspects, process 1400 includes receiving an activation command that indicates activation of semi-persistent timing advance update occasions for the second TAG, wherein measuring the downlink reception timing difference and deriving the timing advance for the second TAG are based at least in part on the activation of the semi-persistent timing advance update occasions for the second TAG.

In a thirty-fourth aspect, alone or in combination with one or more of the first through thirty-third aspects, the activation command includes an indication of a TAG identifier that identifies the second TAG.

In a thirty-fifth aspect, alone or in combination with one or more of the first through thirty-fourth aspects, the activation command includes an indication of a measurement configuration, of a plurality of configured measurement configurations associated with the second TAG, and measuring the downlink reception timing difference is based at least in part on the measurement configuration indicated by the activation command.

In a thirty-sixth aspect, alone or in combination with one or more of the first through thirty-fifth aspects, the activation of the semi-persistent timing advance update occasions for the second TAG occurs at an application time associated with a time offset from the activation command or an acknowledgement for the activation command.

In a thirty-seventh aspect, alone or in combination with one or more of the first through thirty-sixth aspects, process 1400 includes receiving an indication for triggering an aperiodic timing advance update for the second TAG, wherein measuring the downlink reception timing difference and deriving the timing advance for the second TAG are based at least in part on receiving the indication for triggering the aperiodic timing advance update for the second TAG.

In a thirty-eighth aspect, alone or in combination with one or more of the first through thirty-seventh aspects, process 1400 includes receiving, from a network node, a cell or TAG activation command that indicates the activation of the one or more cells in the second TAG.

In a thirty-ninth aspect, alone or in combination with one or more of the first through thirty-eighth aspects, transmitting, on one or more cells in the second TAG, the one or more uplink communications using the timing advance for the second TAG includes transmitting the one or more uplink communications using the timing advance for the second TAG after a timing advance application time associated with the cell or TAG activation command, wherein the timing advance application time is based at least in part on an offset from the cell or TAG activation command, or an offset from an acknowledgment for the cell or TAG activation command.

In a fortieth aspect, alone or in combination with one or more of the first through thirty-ninth aspects, the cell or TAG activation command measuring the downlink reception timing difference and deriving the timing advance for the second TAG are performed based at least in part on receiving the cell or TAG activation command.

In a forty-first aspect, alone or in combination with one or more of the first through fortieth aspects, process 1400 includes storing a stored value for the timing advance update for the second TAG as an absolute time or a quantized time based at least in part on a timing unit.

In a forty-second aspect, alone or in combination with one or more of the first through forty-first aspects, transmitting, on the one or more cells in the second TAG, the one or more uplink communications using the timing advance for the second TAG includes transmitting, on the one or more cells in the second TAG, the one or more uplink communications using an applied value for the timing advance for the second TAG, wherein the applied value for the timing advance for the second TAG is based at least in part on the stored value for the timing advance for the second TAG and at least one of a sub-carrier spacing of a first uplink transmission after reception of a cell or TAG activation command that indicates the activation of the one or more cells in the second TAG, a largest or smallest subcarrier spacing among active or configured BWPs of the one or more cells in the second TAG, or a subcarrier spacing of a reference BWP of a reference cell in the second TAG.

In a forty-third aspect, alone or in combination with one or more of the first through forty-second aspects, measuring the downlink reception timing difference includes measuring the downlink reception timing difference based at least in part on a first reference signal associated with the reference active cell and a second reference signal associated with the reference deactivated cell, wherein the first reference signal is associated with a first TRP identifier corresponding to a first TRP associated with the first TAG, and wherein the second reference signal is associated with a second TRP identifier corresponding to a second TRP associated with the second TAG.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include one or more of a measurement component 1508, a derivation component 1510, a selection component 1512, and/or a storage component 1514, among other examples.

In some aspects, the apparatus 1500 may be configured to perform one or more operations described herein in connection with FIGS. 6-13C. Additionally, or alternatively, the apparatus 1500 may be configured to perform one or more processes described herein, such as process 1400 of FIG. 14, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE described in connection with FIG. 2. In some aspects, the transmission component 1504 may be co-located with the reception component 1502 in a transceiver.

The measurement component 1508 may measure a downlink reception timing difference between a reference active cell in a first TAG and a reference deactivated cell in a second TAG, wherein the second TAG is a deactivated TAG. The derivation component 1510 may derive a timing advance for the second TAG based at least in part on a timing advance for the first TAG and the downlink reception timing difference between the reference active cell and the reference deactivated cell. The transmission component 1504 may transmit, on one or more cells in the second TAG, one or more uplink communications using the timing advance for the second TAG, in connection with activation of the one or more cells in the second TAG.

The reception component 1502 may receive a timing advance command that includes an indication of the timing advance for the first TAG.

The reception component 1502 may receive, from a network node, an indication of a TAG identifier that identifies the first TAG.

The reception component 1502 may receive, from a network node, an indication of a TAG identifier that identifies the second TAG.

The selection component 1512 may select the second TAG from one or more deactivated TAGs that include one or more candidate SpCells.

The reception component 1502 may receive, from a network node, an indication that identifies the reference active cell and the deactivated reference cell.

The reception component 1502 may receive, from a network node, an indication of a downlink BWP identifier that identifies the second BWP.

The reception component 1502 may receive, from a network node, an indication of a first reference signal identifier that identifies the first reference signal and a second reference signal identifier that identifies the second reference signal.

The selection component 1512 may select the first reference signal from a first set of downlink reference signals configured for the reference active cell, and the second reference signal from a second set of downlink reference signals configured for the reference deactivated cell.

The reception component 1502 may receive, from a network node, timing information relating to a downlink transmission timing difference between the reference active cell and the reference deactivated cell and a difference between uplink and downlink timing gaps in the reference active cell and the reference deactivated cell, wherein deriving the timing advance for the second TAG comprises deriving the timing advance for the second TAG based at least in part on a timing advance for the first TAG, the downlink reception timing difference between the reference active cell and the reference deactivated cell, and the timing information.

The transmission component 1504 may transmit, to a network node, a UE capability report indicating a UE capability for timing advance derivation, wherein the UE capability report indicates at least one of a maximum quantity of deactivated cells or TAGs for which timing advance derivation is supported, one or more time-domain types supported for downlink reception timing difference measurement and timing advance derivation, or a quantity of time-domain types supported simultaneously for a deactivated TAG.

The reception component 1502 may receive an activation command that indicates activation of semi-persistent timing advance update occasions for the second TAG, wherein measuring the downlink reception timing difference and deriving the timing advance for the second TAG are based at least in part on the activation of the semi-persistent timing advance update occasions for the second TAG.

The reception component 1502 may receive an indication for triggering an aperiodic timing advance update for the second TAG, wherein measuring the downlink reception timing difference and deriving the timing advance for the second TAG are based at least in part on receiving the indication for triggering the aperiodic timing advance update for the second TAG.

The reception component 1502 may receive, from a network node, a cell or TAG activation command that indicates the activation of the one or more cells in the second TAG.

The storage component 1514 may store a stored value for the timing advance update for the second TAG as an absolute time or a quantized time based at least in part on a timing unit.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a user equipment (UE), comprising: measuring a downlink reception timing difference between a reference active cell in a first timing advance group (TAG) and a reference deactivated cell in a second TAG, wherein the second TAG is a deactivated TAG; deriving a timing advance for the second TAG based at least in part on a timing advance for the first TAG and the downlink reception timing difference between the reference active cell and the reference deactivated cell; and transmitting, on one or more cells in the second TAG, one or more uplink communications using the timing advance for the second TAG, in connection with activation of the one or more cells in the second TAG.
Aspect 2: The method of Aspect 1, further comprising: receiving a timing advance command that includes an indication of the timing advance for the first TAG.
Aspect 3: The method of any of Aspects 1-2, wherein the first TAG is a primary TAG, or wherein the first TAG is an active secondary TAG selected, from a set of one or more active secondary TAGs, based at least in part on a TAG identifier.
Aspect 4: The method of any of Aspects 1-3, further comprising: receiving, from a network node, an indication of a TAG identifier that identifies the first TAG.
Aspect 5: The method of any of Aspects 1-4, further comprising: receiving, from a network node, an indication of a TAG identifier that identifies the second TAG.
Aspect 6: The method of any of Aspects 1-4, further comprising: selecting the second TAG from one or more deactivated TAGs that include one or more candidate special cells (SpCells).
Aspect 7: The method of any of Aspects 1-6, wherein the reference active cell is a special cell (SpCell) in the first TAG, and wherein the reference deactivated cell is a candidate SpCell in the second TAG.
Aspect 8: The method of any of Aspects 1-7, further comprising: receiving, from a network node, an indication that identifies the reference active cell and the deactivated reference cell.
Aspect 9: The method of any of Aspects 1-8, wherein measuring the downlink reception timing difference comprises: measuring the downlink reception timing difference based at least in part on a first reference signal in a first bandwidth part (BWP) associated with the reference active cell and a second reference signal in a second BWP associated with the reference deactivated cell.
Aspect 10: The method of Aspect 9, wherein the first BWP is an active downlink BWP associated with the reference active cell.
Aspect 11: The method of any of Aspects 9-10, wherein the second BWP is an initial downlink BWP associated with the reference deactivated cell, wherein the second BWP is a downlink BWP with a lowest BWP identifier in a set of downlink BWPs associated with the reference deactivated cell, or wherein the second BWP is a downlink BWP with a highest BWP identifier in the set of downlink BWPs associated with the reference deactivated cell.
Aspect 12: The method of any of Aspects 9-11, further comprising: receiving, from a network node, an indication of a downlink BWP identifier that identifies the second BWP.
Aspect 13: The method of any of Aspects 9-12, wherein the first reference signal is a strongest synchronization signal block (SSB) associated with the reference active cell or a downlink reference signal associated with an active or indicated transmission configuration indicator (TCI) state for the reference active cell, and wherein the second reference signal is a strongest SSB associated with the reference deactivated cell or a downlink reference signal associated with an indicated TCI state for reference deactivated cell.
Aspect 14: The method of any of Aspects 9-13, further comprising: receiving, from a network node, an indication of a first reference signal identifier that identifies the first reference signal and a second reference signal identifier that identifies the second reference signal.
Aspect 15: The method of any of Aspects 9-13, further comprising: selecting the first reference signal from a first set of downlink reference signals configured for the reference active cell, and the second reference signal from a second set of downlink reference signals configured for the reference deactivated cell.
Aspect 16: The method of any of Aspects 9-15, wherein the first reference signal and the second reference signal are associated with a same center frequency and a same sub-carrier spacing.
Aspect 17: The method of any of Aspects 9-16, wherein deriving the timing advance for the second TAG comprises: deriving the timing advance for the second TAG in connection with a determination that a first reception quality measurement associated with the first reference signal and a second reception quality measurement associated with the second reference signal satisfy a threshold.
Aspect 18: The method of any of Aspects 1-17, wherein the reference active cell and the reference deactivated cell operate in a same frequency band, or wherein a difference between a frequency associated with the reference active cell and a frequency associated with the reference deactivated cell satisfies a threshold.
Aspect 19: The method of any of Aspects 1-18, wherein deriving the timing advance for the second TAG comprises: deriving the timing advance for the second TAG in connection with at least one of a determination that a downlink transmission timing difference between the reference active cell and the reference deactivated cell satisfies a threshold, or a determination that the downlink reception timing difference between the reference active cell and the reference deactivated cell satisfies a threshold.
Aspect 20: The method of any of Aspects 1-19, wherein measuring the downlink reception timing difference comprises: measuring a time difference between reception of first or strongest detected paths of corresponding downlink frames from the reference active cell and the reference deactivated cell.
Aspect 21: The method of any of Aspects 1-20, further comprising: receiving, from a network node, timing information relating to a downlink transmission timing difference between the reference active cell and the reference deactivated cell and a difference between uplink and downlink timing gaps in the reference active cell and the reference deactivated cell, wherein deriving the timing advance for the second TAG comprises deriving the timing advance for the second TAG based at least in part on a timing advance for the first TAG, the downlink reception timing difference between the reference active cell and the reference deactivated cell, and the timing information.
Aspect 22: The method of Aspect 21, wherein the timing information includes an indication of a timing offset value based at least in part on the downlink transmission timing difference between the reference active cell and the reference deactivated cell and the difference between the uplink and downlink timing gaps in the reference active cell and the reference deactivated cell.
Aspect 23: The method of any of Aspects 21-22, wherein the timing information includes at least one of an indication of the downlink transmission timing difference between the reference active cell and the reference deactivated cell, or an indication of an uplink timing difference between the reference active cell and the reference deactivated cell.
Aspect 24: The method of any of Aspects 21-23, wherein the timing information includes respective indications of downlink frame timings for the reference active cell and the reference deactivated cell, or respective indications of uplink frame timings for the reference active cell and the reference deactivated cell.
Aspect 25: The method of any of Aspects 1-24, wherein deriving the timing advance for the second TAG comprises: periodically deriving the timing advance for the second TAG in timing advance update occasions associated with a periodicity.
Aspect 26: The method of Aspect 25, wherein measuring the downlink reception timing difference comprises: measuring the downlink reception timing difference based at least in part on a first reference signal associated with the reference active cell and a second reference signal associated with the reference deactivated cell, wherein the first reference signal is included in a first periodic reference signal set with a first periodicity and the second reference signal is included in a second periodic reference signal set with a second periodicity, and wherein the periodicity associated with the timing advance update occasions is based at least in part on at least one of the first periodicity or the second periodicity.
Aspect 27: The method of Aspect 26, wherein the periodicity associated with the timing advance update occasions is equal to the first periodicity, and the timing advance update occasions occur at a time offset after a last reference signal in the first periodic reference signal set, or wherein the periodicity associated with the timing advance update occasions is equal to the second periodicity, and the timing advance update occasions occur at the time offset after a last reference signal in the second periodic reference signal set.
Aspect 28: The method of any of Aspects 25-27, wherein measuring the downlink reception timing difference comprises: measuring the downlink reception timing difference based at least in part on a first periodic reference signal associated with the reference active cell and a second periodic reference signal associated with the reference deactivated cell, wherein the first periodic reference signal is associated with a first periodicity and the second periodic reference signal is associated with a second periodicity, and wherein the periodicity associated with the timing advance update occasions is based at least in part on at least one of the first periodicity or the second periodicity.
Aspect 29: The method of Aspect 28, wherein the first periodicity is equal to the second periodicity, and wherein the periodicity associated with the timing advance update occasions is equal to the first periodicity and the second periodicity.
Aspect 30: The method of any of Aspects 28-29, wherein the timing advance update occasions occur at a time offset after occasions of the first periodic reference signal or after occasions of the second periodic reference signal.
Aspect 31: The method of any of Aspects 25-30, wherein measuring the downlink reception timing difference comprises: periodically measuring the downlink reception timing difference in measurement occasions, wherein periodically deriving the timing advance for the second TAG comprises deriving the timing advance for the second TAG, in a timing advance update occasion, based at least in part on filtered measurements of the downlink reception timing difference in a plurality of measurement occasions.
Aspect 32: The method of any of Aspects 25-31, wherein periodically deriving the timing advance for the second TAG comprises: deriving the timing advance for the second TAG, in a timing advance update occasion, based at least in part on filtered timing advances for the second TAG derived in one or more previous timing advance update occasions.
Aspect 33: The method of any of Aspects 1-32, further comprising: transmitting, to a network node, a UE capability report indicating a UE capability for timing advance derivation, wherein the UE capability report indicates at least one of a maximum quantity of deactivated cells or TAGs for which timing advance derivation is supported, one or more time-domain types supported for downlink reception timing difference measurement and timing advance derivation, or a quantity of time-domain types supported simultaneously for a deactivated TAG.
Aspect 34: The method of any of Aspects 1-33, further comprising: receiving an activation command that indicates activation of semi-persistent timing advance update occasions for the second TAG, wherein measuring the downlink reception timing difference and deriving the timing advance for the second TAG are based at least in part on the activation of the semi-persistent timing advance update occasions for the second TAG.
Aspect 35: The method of Aspect 34, wherein the activation command includes an indication of a TAG identifier that identifies the second TAG.
Aspect 36: The method of Aspect 35, wherein the activation command includes an indication of a measurement configuration, of a plurality of configured measurement configurations associated with the second TAG, and wherein measuring the downlink reception timing difference is based at least in part on the measurement configuration indicated by the activation command.
Aspect 37: The method of any of Aspects 34-36, wherein the activation of the semi-persistent timing advance update occasions for the second TAG occurs at an application time associated with a time offset from the activation command or an acknowledgement for the activation command.
Aspect 38: The method of any of Aspects 1-24 and 33, further comprising: receiving an indication for triggering an aperiodic timing advance update for the second TAG, wherein measuring the downlink reception timing difference and deriving the timing advance for the second TAG are based at least in part on receiving the indication for triggering the aperiodic timing advance update for the second TAG.
Aspect 39: The method of any of Aspects 1-38, further comprising: receiving, from a network node, a cell or TAG activation command that indicates the activation of the one or more cells in the second TAG.
Aspect 40: The method of Aspect 39, wherein transmitting, on one or more cells in the second TAG, the one or more uplink communications using the timing advance for the second TAG comprises: transmitting the one or more uplink communications using the timing advance for the second TAG after a timing advance application time associated with the cell or TAG activation command, wherein the timing advance application time is based at least in part on an offset from the cell or TAG activation command, or an offset from an acknowledgment for the cell or TAG activation command.
Aspect 41: The method of any of Aspects 39-40, wherein the cell or TAG activation command measuring the downlink reception timing difference and deriving the timing advance for the second TAG are performed based at least in part on receiving the cell or TAG activation command.
Aspect 42: The method of any of Aspects 1-41, further comprising: storing a stored value for the timing advance update for the second TAG as an absolute time or a quantized time based at least in part on a timing unit.
Aspect 43: The method of Aspect 42, wherein transmitting, on the one or more cells in the second TAG, the one or more uplink communications using the timing advance for the second TAG comprises: transmitting, on the one or more cells in the second TAG, the one or more uplink communications using an applied value for the timing advance for the second TAG, wherein the applied value for the timing advance for the second TAG is based at least in part on the stored value for the timing advance for the second TAG and at least one of a sub-carrier spacing of a first uplink transmission after reception of a cell or TAG activation command that indicates the activation of the one or more cells in the second TAG, a largest or smallest subcarrier spacing among active or configured bandwidth parts (BWPs) of the one or more cells in the second TAG, or a subcarrier spacing of a reference BWP of a reference cell in the second TAG.
Aspect 44: The method of any of Aspects 1-43, wherein measuring the downlink reception timing difference comprises: measuring the downlink reception timing difference based at least in part on a first reference signal associated with the reference active cell and a second reference signal associated with the reference deactivated cell, wherein the first reference signal is associated with a first transmit receive point (TRP) identifier corresponding to a first TRP associated with the first TAG, and wherein the second reference signal is associated with a second TRP identifier corresponding to a second TRP associated with the second TAG.
Aspect 45: An apparatus for wireless communication at a device, comprising a processor; memory coupled with the processor; and instructions stored in the memory and executable by the processor to cause the apparatus to perform the method of one or more of Aspects 1-44.
Aspect 46: A device for wireless communication, comprising a memory and one or more processors coupled to the memory, the one or more processors configured to perform the method of one or more of Aspects 1-44.
Aspect 47: An apparatus for wireless communication, comprising at least one means for performing the method of one or more of Aspects 1-44.
Aspect 48: A non-transitory computer-readable medium storing code for wireless communication, the code comprising instructions executable by a processor to perform the method of one or more of Aspects 1-44.
Aspect 49: A non-transitory computer-readable medium storing a set of instructions for wireless communication, the set of instructions comprising one or more instructions that, when executed by one or more processors of a device, cause the device to perform the method of one or more of Aspects 1-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
measure a downlink reception timing difference between a reference active cell in a first timing advance group (TAG) and a reference deactivated cell in a second TAG, wherein the second TAG is a deactivated TAG;
derive a timing advance for the second TAG based at least in part on a timing advance for the first TAG and the downlink reception timing difference between the reference active cell and the reference deactivated cell; and
transmit, on one or more cells in the second TAG, one or more uplink communications using the timing advance for the second TAG, in connection with activation of the one or more cells in the second TAG.

2. The UE of claim 1, wherein the one or more processors are further configured to:
receive a timing advance command that includes an indication of the timing advance for the first TAG.

3. The UE of claim 1, wherein the one or more processors, to measure the downlink reception timing difference, are configured to:
measure the downlink reception timing difference based at least in part on a first reference signal in a first bandwidth part (BWP) associated with the reference active cell and a second reference signal in a second BWP associated with the reference deactivated cell.

4. The UE of claim 3, wherein the first reference signal is a strongest synchronization signal block (SSB) associated with the reference active cell or a downlink reference signal associated with an active or indicated transmission configuration indicator (TCI) state for the reference active cell, and wherein the second reference signal is a strongest SSB associated with the reference deactivated cell or a downlink reference signal associated with an indicated TCI state for reference deactivated cell.

5. The UE of claim 1, wherein the one or more processors, to derive the timing advance for the second TAG, are configured to:
derive the timing advance for the second TAG in connection with at least one of a determination that a downlink transmission timing difference between the reference active cell and the reference deactivated cell satisfies a threshold, or a determination that the downlink reception timing difference between the reference active cell and the reference deactivated cell satisfies a threshold.

6. The UE of claim 1, wherein the one or more processors, to measure the downlink reception timing difference, are configured to:
measure a time difference between reception of first or strongest detected paths of corresponding downlink frames from the reference active cell and the reference deactivated cell.

7. The UE of claim 1, wherein the one or more processors are further configured to:
receive, from a network node, timing information relating to a downlink transmission timing difference between the reference active cell and the reference deactivated cell and a difference between uplink and downlink timing gaps in the reference active cell and the reference deactivated cell, wherein deriving the timing advance for the second TAG comprises deriving the timing advance for the second TAG based at least in part on a timing advance for the first TAG, the downlink reception timing difference between the reference active cell and the reference deactivated cell, and the timing information.

8. The UE of claim 1, wherein the one or more processors, to derive the timing advance for the second TAG, are configured to:
periodically derive the timing advance for the second TAG in timing advance update occasions associated with a periodicity.

9. The UE of claim 8, wherein the one or more processors, to measure the downlink reception timing difference, are configured to:
measure the downlink reception timing difference based at least in part on a first reference signal associated with the reference active cell and a second reference signal associated with the reference deactivated cell, wherein the first reference signal is included in a first periodic reference signal set with a first periodicity and the second reference signal is included in a second periodic reference signal set with a second periodicity, and wherein the periodicity associated with the timing advance update occasions is based at least in part on at least one of the first periodicity or the second periodicity.

10. The UE of claim 9, wherein the periodicity associated with the timing advance update occasions is equal to the first periodicity, and the timing advance update occasions occur at a time offset after a last reference signal in the first periodic reference signal set, or wherein the periodicity associated with the timing advance update occasions is equal to the second periodicity, and the timing advance update occasions occur at the time offset after a last reference signal in the second periodic reference signal set.

11. The UE of claim 8, wherein the one or more processors, to measure the downlink reception timing difference, are configured to:
measure the downlink reception timing difference based at least in part on a first periodic reference signal associated with the reference active cell and a second periodic reference signal associated with the reference deactivated cell, wherein the first periodic reference signal is associated with a first periodicity and the second periodic reference signal is associated with a second periodicity, and wherein the periodicity associated with the timing advance update occasions is based at least in part on at least one of the first periodicity or the second periodicity.

12. The UE of claim 11, wherein the first periodicity is equal to the second periodicity, and wherein the periodicity associated with the timing advance update occasions is equal to the first periodicity and the second periodicity.

13. The UE of claim 1, wherein the one or more processors are further configured to:
receive an activation command that indicates activation of semi-persistent timing advance update occasions for the second TAG, wherein measuring the downlink reception timing difference and deriving the timing advance for the second TAG are based at least in part on the activation of the semi-persistent timing advance update occasions for the second TAG.

14. The UE of claim 13, wherein the activation command includes an indication of a TAG identifier that identifies the second TAG.

15. The UE of claim 13, wherein the activation of the semi-persistent timing advance update occasions for the second TAG occurs at an application time associated with a time offset from the activation command or an acknowledgement for the activation command.

16. The UE of claim 1, wherein the one or more processors are further configured to:
receive an indication for triggering an aperiodic timing advance update for the second TAG, wherein the one or more processors are configured to measure the downlink reception timing difference and derive the timing advance for the second TAG based at least in part on receiving the indication for triggering the aperiodic timing advance update for the second TAG.

17. The UE of claim 1, wherein the one or more processors are further configured to:
receive, from a network node, a cell or TAG activation command that indicates the activation of the one or more cells in the second TAG.

18. The UE of claim 17, wherein the one or more processors, to transmit, on one or more cells in the second TAG, the one or more uplink communications using the timing advance for the second TAG, are configured to:
transmit the one or more uplink communications using the timing advance for the second TAG after a timing advance application time associated with the cell or TAG activation command, wherein the timing advance application time is based at least in part on an offset from the cell or TAG activation command, or an offset from an acknowledgment for the cell or TAG activation command.

19. The UE of claim 17, wherein the cell or TAG activation command measuring the downlink reception timing difference and deriving the timing advance for the second TAG are performed based at least in part on receiving the cell or TAG activation command.

20. A method of wireless communication performed by a user equipment (UE), comprising:
measuring a downlink reception timing difference between a reference active cell in a first timing advance group (TAG) and a reference deactivated cell in a second TAG, wherein the second TAG is a deactivated TAG;
deriving a timing advance for the second TAG based at least in part on a timing advance for the first TAG and the downlink reception timing difference between the reference active cell and the reference deactivated cell; and
transmitting, on one or more cells in the second TAG, one or more uplink communications using the timing advance for the second TAG, in connection with activation of the one or more cells in the second TAG.

21. The method of claim 20, further comprising:
receiving a timing advance command that includes an indication of the timing advance for the first TAG.

22. The method of claim 20, wherein measuring the downlink reception timing difference comprises:
measuring the downlink reception timing difference based at least in part on a first reference signal in a first bandwidth part (BWP) associated with the reference active cell and a second reference signal in a second BWP associated with the reference deactivated cell.

23. The method of claim 20, further comprising:
receiving, from a network node, timing information relating to a downlink transmission timing difference between the reference active cell and the reference deactivated cell and a difference between uplink and downlink timing gaps in the reference active cell and the reference deactivated cell, wherein deriving the timing advance for the second TAG comprises deriving the timing advance for the second TAG based at least in part on a timing advance for the first TAG, the downlink reception timing difference between the reference active cell and the reference deactivated cell, and the timing information.

24. The method of claim 20, wherein deriving the timing advance for the second TAG comprises:
periodically deriving the timing advance for the second TAG in timing advance update occasions associated with a periodicity.

25. The method of claim 20, further comprising:
receiving an activation command that indicates activation of semi-persistent timing advance update occasions for the second TAG, wherein measuring the downlink reception timing difference and deriving the timing advance for the second TAG are based at least in part on the activation of the semi-persistent timing advance update occasions for the second TAG.

26. The method of claim 20, further comprising:
receiving an indication for triggering an aperiodic timing advance update for the second TAG, wherein measuring the downlink reception timing difference and deriving the timing advance for the second TAG are based at least in part on receiving the indication for triggering the aperiodic timing advance update for the second TAG.

27. The method of claim 20, further comprising:
receiving, from a network node, a cell or TAG activation command that indicates the activation of the one or more cells in the second TAG.

28. The method of claim 27, wherein transmitting, on one or more cells in the second TAG, the one or more uplink communications using the timing advance for the second TAG comprises:
transmitting the one or more uplink communications using the timing advance for the second TAG after a timing advance application time associated with the cell or TAG activation command, wherein the timing advance application time is based at least in part on an offset from the cell or TAG activation command, or an offset from an acknowledgment for the cell or TAG activation command.

29. A non-transitory computer-readable medium storing a set of instructions for wireless communication, the set of instructions comprising:
one or more instructions that, when executed by one or more processors of a user equipment (UE), cause the UE to:
measure a downlink reception timing difference between a reference active cell in a first timing advance group (TAG) and a reference deactivated cell in a second TAG, wherein the second TAG is a deactivated TAG;
derive a timing advance for the second TAG based at least in part on a timing advance for the first TAG and the downlink reception timing difference between the reference active cell and the reference deactivated cell; and
transmit, on one or more cells in the second TAG, one or more uplink communications using the timing advance for the second TAG, in connection with activation of the one or more cells in the second TAG.

30. An apparatus for wireless communication, comprising:
means for measuring a downlink reception timing difference between a reference active cell in a first timing advance group (TAG) and a reference deactivated cell in a second TAG, wherein the second TAG is a deactivated TAG;
means for deriving a timing advance for the second TAG based at least in part on a timing advance for the first TAG and the downlink reception timing difference between the reference active cell and the reference deactivated cell; and
means for transmitting, on one or more cells in the second TAG, one or more uplink communications using the timing advance for the second TAG, in connection with activation of the one or more cells in the second TAG.
